(19) United States
(12) Patent Application Publication
(10) Pub. No.: US 2026/0217614 A1
(43) Pub. Date: Jul. 30, 2026

(54) AUTONOMOUS SYSTEM AND METHOD FOR THE KINETIC MANAGEMENT AND STABILIZATION OF FRESH CONCRETE PROPERTIES

(71) Applicant: Sensolyzer Advanced Sensing Systems Ltd., Herzliya (IL)

(72) Inventor: Yaniv KNOP, Herzliya (IL)

(21) Appl. No.: 19/630,074

(22) Filed: Mar. 26, 2026

Related U.S. Application Data
(63) Continuation-in-part of application No. 19/311,488, filed on Aug. 27, 2025.
Application No. 19/311,488 is a continuation-in-part of application No. 18/939,807, filed on Nov. 7, 2024.
Application No. 18/939,807 is a continuation-in-part of application No. 18/514,023, filed on Nov. 20, 2023, now Pat. No. 12,558,812.
Application No. 18/514,023 is a continuation-in-part of application No. PCT/IL2022/050173, filed on Feb. 14, 2022.
(63) Continuation-in-part of application No. 18/953,836, filed on Nov. 20, 2024.
Application No. 18/953,836 is a continuation-in-part of application No. 18/514,023, filed on Nov. 20, 2023, now Pat. No. 12,558,812.
(60) Provisional application No. 63/192,693, filed on May 25, 2021.

(51) Int. Cl. C04B 40/00; B28C 5/42; B28C 7/02; B28C 7/04; C04B 28/00; C04B 103/30; C04B 111/00; G05B 13/04

(52) U.S. Cl. CPC C04B 40/0032; B28C 5/422; B28C 7/024; B28C 7/0409; B28C 7/0418; C04B 28/006; G05B 13/048; C04B 2103/302; C04B 2111/00181

(57) ABSTRACT

The invention provides a method and system for the autonomous management of fresh concrete properties via an autonomous processing core (APC) functioning as an extended production line. The system utilises multi-modal data comprising a visual primary signal and auxiliary electronic signals. By normalising data against rotational speed and volume, the APC identifies a stabilisation event representing the conclusion of at least one chemical or physical change occurring in the concrete from the onset of production and throughout its transportation, such as aggregate absorption, contaminant saturation, and initial hydration reactions, thereby completing the production of the concrete mix initiated at a stationary batching plant. A control interlock is executed for a delay interval defined by a dynamic saturation index (DSI) to prevent premature admixture sequestration. Following the delay, the APC directs a staged dosing protocol of incremental doses adjusted based on deviations from a target material property. Homogenisation is verified through a coefficient of variation (CoV) protocol. The system further facilitates networked fleet management, the production of both regular and special concrete mixes, 3D printing, geopolymer mixtures, cement-reduction protocols, and continuous manual remote operation of the system.

### CROSS-REFERENCE TO RELATED APPLICATIONS

This application is a Continuation-in-Part of U.S. patent application Ser. No. 19/311,488, filed on Aug. 27, 2025, which is a Continuation-in-Part of U.S. patent application Ser. No. 18/939,807, filed on Nov. 7, 2024, which is a Continuation-in-Part of U.S. patent application Ser. No. 18/514,023, filed on Nov. 20, 2023, now U.S. Pat. No. 12,558,812, which is a Continuation-in-Part of of PCT Patent Application No. PCT/IL2022/050173 having International filing date of Feb. 14, 2022, which claims the benefit of priority of U.S. Provisional Patent Application No. 63/192,693, filed May 25, 2021.

This application is also a Continuation-in-Part of U.S. patent application Ser. No. 18/953,836, filed on Nov. 20, 2024, which is a Continuation-in-Part of U.S. patent application Ser. No. 18/514,023, filed on Nov. 20, 2023, now U.S. Pat. No. 12,558,812, which is a Continuation-in-Part of PCT Patent Application No. PCT/IL2022/050173 having International filing date of Feb. 14, 2022, which claims the benefit of priority of U.S. Provisional Patent Application No. 63/192,693, filed May 25, 2021.

The entire disclosures of the above-referenced patent applications are incorporated herein by reference.

### TECHNICAL FIELD OF THE INVENTION

The present invention relates generally to the field of concrete production, rheology management, and performance stabilization during transit. More specifically, the invention relates to a proactive AI-driven method and system for the kinetic management and optimization of fresh concrete properties through the precision dosing of different chemical admixtures over time and during transportation. The invention utilizes a multi-modal real-time sensory feedback loop which incorporates visual data analysis, hydraulic pressure monitoring, and acoustic signatures, and may further incorporate thermal profiles and rotational speed to determine the optimal timing, sequence, and volume for the introduction of chemical components. In a particular aspect, the system is configured as an autonomous cyber-physical concrete production system (Sensolyzer™) to manage hydration kinetics and physical transitions, such as aggregate absorption and the influence of contaminants like clay, while preventing mixture segregation and bleeding. Furthermore, the invention facilitates the stabilization of fresh concrete properties, including air content, to ensure structural durability and consistency across various applications, including 3D printing and geopolymer concrete production.

### BACKGROUND

The production of high-quality concrete is a complex industrial process that is exceptionally sensitive to the quality of raw materials, environmental variables, and the specific chemical interactions of the mix components. Traditionally, the introduction of chemical admixtures, such as water reducers, accelerators, air entrainers, plasticizers, or retarders, occurs at a central stationary batching plant. However, chemical reactions and physical absorption characteristics of raw materials and the presence of contaminants such as clays, combined with environmental factors such as ambient temperature, humidity, and the varying moisture content of aggregates, often cause the concrete to deviate from its intended required properties during the transit phase to a job site.

Existing solutions have attempted to address these challenges by introducing monitoring systems on the mixing truck. For example, the applicant's earlier disclosures, such as the framework established in U.S. Pat. No. 12,558,812, provided a robust method for monitoring hydraulic pressure to calculate concrete volume and slump. These earlier systems further utilized artificial intelligence to predict the need for adjustments based on historical and real-time data, as disclosed in U.S. Patent Publication No. 2025/0059101.

Furthermore, the applicant's U.S. Patent Publication No. 2025/0084006 provides a critical advancement in hardware by disclosing a protected sensor assembly, including a camera and acoustic sensors, mounted on the charging chute to withstand the harsh environment of a mixing drum. Most recently, U.S. Patent Publication No. 2025/0375922 established a method for detecting moisture states and clay contaminants through the identification of specific thermal signatures and hydration energy profiles.

While these systems represent a significant advancement in the state of the art by providing the necessary sensory hardware and predictive analytics for monitoring concrete, a technical gap remains regarding the autonomous physical and chemical execution of the dosing process itself. A significant problem in existing prior art is the “initial absorption” effect and the initial hydration reactions that occur within the first minutes of mixing and continue throughout the transport of the concrete. When chemical admixtures are added during the initial mixing process, they are often sequestered into the pores of dry or semi-dry aggregates along with the initial batch water or react with contaminants such as clay. This results in a permanent loss of chemical efficacy, requiring higher dosages which can compromise the final structural strength of the concrete and increase production costs.

Furthermore, the initial hydration of cement components may reduce the efficiency of the admixtures if they are introduced before the mix reaches a state of kinetic readiness. Existing systems typically treat admixtures as a single category, ignoring the competitive chemical reactions and molecular interference that occur when different agents, such as polycarboxylates (PCE) and gluconates, are introduced simultaneously. There is a long-felt need for a system that does not merely react to a loss of slump, but instead manages the hydration process based on the physical state of the mix and defines the precise protocol for producing and stabilizing the properties of concrete. Unlike the prior art, which primarily provides data for a human operator to act upon, there is a need for an autonomous cyber-physical concrete production system capable of observing, deciding, and acting entirely on its own to maintain chemical stability through an integrated command and execution architecture.

### Evolution of the System

The present invention represents a technological evolution from the passive monitoring systems disclosed in the parent applications toward an integrated autonomous cyber-physical production system. While the prior art and earlier disclosures focused on the observation of bulk macroworld parameters, such as slump and temperature, to describe a static material state, the present disclosure introduces an autonomous processing core (APC) configured to manage the microworld kinetics of the concrete mix. This evolution shifts the technical focus from reactive monitoring to proactive control, specifically through the identification of a chemical receptivity state.

Unlike earlier systems that provided a digital proxy for manual interventions, the current system functions as an integrated command and execution architecture. It utilizes multi-modal normalization of both visual and mechanical signals to identify a stabilization event representing the simultaneous conclusion of aggregate absorption, contaminant saturation, and initial hydration reactions. By managing the formation of a molecular lubrication layer at the particle level, the system ensures material stability and chemical efficacy throughout a projected operational window, thereby providing a significant advancement in the autonomous production and stabilization of fresh concrete properties.

### SUMMARY OF THE INVENTION

The present invention provides a significant advancement in the field of automated concrete production management by transitioning from passive monitoring to active, kinetic-based control of concrete hydration. A primary objective of the invention is to overcome the physical and chemical changes that occur in the concrete matrix over time, specifically from the initial moment water is added to the mix until a final placement or discharge event. This involves addressing the technical challenges associated with the initial aggregate absorption phase, contaminant saturation, and the subsequent kinetic transitions that govern material stability. In this phase, the premature introduction of chemical admixtures often leads to the sequestration of active agents within the pores of dry or contaminated aggregates, a phenomenon that the present invention proactively prevents through the execution of an automated kinetic protocol by the autonomous processing core.

Traditional systems often fail to account for this physical phenomenon, leading to the sequestration and subsequent loss of chemical efficacy. The present invention solves this critical problem through a reactive kinetic control protocol and a hardware-anchored, computer-implemented method that utilizes a high-precision sensor feedback loop comprising image processing, temperature, normalized hydraulic data, and acoustic data to gate the delivery of admixtures.

By specifically identifying a stabilization event through the multi-modal analysis of visual, hydraulic, acoustic, or temperature signatures, and enforcing a mechanical inhibit period via a control interlock, the system ensures that chemical admixtures are only introduced once the concrete mix has achieved a stable physical and chemical state. Alternatively, the autonomous processing core (APC) ensures the mixture is actively brought to a stable state in accordance with defined technical specifications as part of a continuous production process. This methodology results in a concrete product with superior consistency and optimized properties, such as workability, while facilitating a significant reduction in the required volumes of chemical admixtures, cement, and water. This approach effectively overcomes the limitations of prior art systems that rely solely on fresh concrete properties, such as slump prediction or generalized AI monitoring, by improving the reliability of measurements including workability, air content, and specific weight. Consequently, the system allows for the successful use of lower-quality raw materials or clay-contaminated aggregates that would otherwise compromise the structural integrity and quality of the final product.

In one aspect, the invention provides a method for the precision dosing of chemical admixtures into a fresh concrete mix within a rotating mixing drum via an autonomous processing core (APC). This method involves sampling, in Step (I), via a processing unit, multi-modal data comprising a primary electronic signal including visual data from a camera, and one or more auxiliary electronic signals selected from a group comprising: a hydraulic pressure signal from a hydraulic pressure transducer; an acoustic signal from an acoustic sensor; a temperature signal from a temperature sensor; and a rotational speed signal. The acoustic sensor and the camera are housed within a protected sensor assembly mounted adjacent to the rotating mixing drum to identify a specific stabilization event that marks the plateau of the initial hydration and absorption reactions. The hydraulic pressure transducer is fluidly coupled to a hydraulic motor of the rotating mixing drum. In another embodiment, the auxiliary electronic signal is sampled from a pressure sensor submerged inside the concrete matrix within the rotating mixing drum.

The method further involves normalizing, in Step (II), via the processing unit, the primary electronic signal and the one or more auxiliary electronic signals against a rotational speed and a concrete volume of the rotating mixing drum and calculating a rate of change for the normalized primary and auxiliary signals. In Step (III), the processing unit identifies the stabilization event representing the conclusion of an initial aggregate absorption phase, contaminant saturation, and initial hydration reactions. This is achieved by correlating the rate of change calculated in Step (II) with normalized visual flow characteristics derived from the primary electronic signal, detecting a steady-state plateau in said rate of change where a mechanical resistance variance falls below a predetermined threshold, and cross-validating said plateau through real-time image processing of normalized visual kinetic markers and flow patterns from the primary electronic signal.

In response to the identified stabilization event, the processing unit executes, in Step (IV), a control interlock to inhibit an admixtures delivery system for a delay interval. This delay interval is calculated by the processing unit as a dynamic saturation index (DSI) based on the multi-modal data sampled in Step (I) and at least one material variable selected from a group consisting of an aggregate quality, a mix type, and a presence of contaminants, thereby preventing premature admixture sequestration. In a particular embodiment, the processing unit monitors and stabilizes the physical and chemical changes from the moment water hits the mix until discharge, specifically identifying kinetic stabilization of initial hydration reactions involving the aluminate and ferrite components, particularly tricalcium aluminate (C₃A) and tetracalcium aluminoferrite (C₄AF), and the silicate components of the cement.

Upon expiry of the delay interval, the processing unit determines, in Step (V), a staged dosing protocol by establishing a steady-state baseline for the normalized auxiliary electronic signals and quantifying a total required volume of at least one chemical admixture by correlating said steady-state baseline with the visual flow characteristics from the primary electronic signal. The processing unit then generates a sequence of a plurality of incremental doses and corresponding homogenization windows, wherein the magnitude of each dose is dynamically adjusted as a function of deviation between the steady-state baseline and a target material property. The sequence is further calculated as a function of the mix type and a projected operational window until a final placement or discharge event.

The method then involves directing, in Step (VI), the admixtures delivery system to execute the staged dosing protocol by introducing the plurality of incremental doses of at least one chemical admixture from at least one independent reservoir, each dose being between about 0.1% and about 0.5% of a total cement weight. To ensure feedback stability and accurate measurement of resulting property changes such as viscosity, each subsequent dose is inhibited until the processing unit identifies a return to the steady-state baseline in at least one of the primary or auxiliary electronic signals, indicating completion of a chemical dispersion over a homogenization window. This aspect provides the technical advantage of preventing the premature sequestration of chemicals into aggregate pores and ensuring the admixtures act primarily on the cement paste to maximize effectiveness.

In one embodiment, the method further comprises the step of detecting a mixture breaking point by identifying a rapid downward spike or a drop in hydraulic pressure in the auxiliary electronic signal occurring simultaneously with a threshold increase in an acoustic signal and a visual detection of aggregate segregation via the primary electronic signal. This provides the technical advantage of identifying concrete segregation and bleeding in real time, allowing the processing unit to execute a safety interlock to prevent the discharge of structurally compromised batches. The visual processing system is specifically trained using a machine learning architecture to identify early warning signs of this breaking point through the real-time analysis of the flow patterns within the rotating mixing drum, such as the observation of cementitious paste or liquid flowing downward from the upper regions of the drum and the subsequent discharge of water onto the surface of the concrete mass.

By identifying these visual kinetic markers and flow patterns, the processing unit can evaluate and predict an impending loss of homogeneity and execute a safety interlock before the segregation is fully reflected in mechanical resistance changes. This visual data from the primary electronic signal is cross-referenced with the auxiliary electronic signals to provide a multi-modal confirmation of the mixture state, allowing the system to proactively inhibit further admixture delivery or adjust the rotational speed to maintain stability. In a further embodiment, the processing unit verifies the conclusion of the initial aggregate absorption phase by identifying a specific correlation between the stabilization event of an internal pressure signal and a predetermined frequency shift in an acoustic signal. This embodiment enhances the precision of the delay trigger, ensuring that the interlock is not released until the physical state of the mix has truly reached a baseline homogeneity.

In another embodiment, the rotational speed utilized in Step (II) and Step (VI) is derived by the processing unit from the primary electronic signal comprising visual data, or alternatively from a sampled electronic signal from a rotational speed sensor. In a specific configuration, the processing unit dynamically adjusts the magnitude of the plurality of incremental doses as a function of the rotational speed, ensuring that the dosing logic remains accurate regardless of whether the drum is rotating at discharge speed or agitation speed.

In another embodiment, the auxiliary electronic signal is sampled from an acoustic sensor and is filtered to isolate a sound volume of the concrete mix from ambient environmental noise. Utilizing the sound volume as a secondary verification following a dose in Step (VI) provides the advantage of a redundant, multi-modal feedback loop that increases system reliability. In yet another embodiment, the step of introducing the plurality of incremental doses in Step (VI) comprises delivering at least a first chemical admixture from a first reservoir, or sequentially delivering a first chemical admixture and a second chemical admixture separated by a chemical-separation interval. This addresses the long-felt need to manage competitive chemical reactions between different admixture classes.

In a certain embodiment, the first chemical admixture is a water-reducing agent selected from the group consisting of polycarboxylates, lignosulfonates, and naphthalene sulfonates, and the second chemical admixture is a retarding agent selected from the group consisting of sodium gluconate, citric acid, tartaric acid, and phosphonates. The processing unit may also manage agents including setting accelerators such as calcium formate, calcium chloride, water glass, and sodium hydroxide, or provide for the delivery of non-routine doses of retarding agents before discharge for specialized applications such as mass concrete. In a particular embodiment, the water-reducing agent is provided with a solids content of 40% or less, which enhances separation effectiveness and ensures rapid dispersal during the homogenization window.

In a specific embodiment, the processing unit calculates a volume of the concrete mix based on the steady-state baseline established in Step (V) or image analysis value from the primary electronic signal, and adjusts the plurality of incremental doses proportionally. This volume-based adjustment ensures that the concentration of the admixture remains consistent regardless of the batch size.

In a distinct embodiment, the processing unit further samples environmental data comprising ambient temperature and humidity and identifies a hydration state, a workability deviation, or the presence of clay contaminants by identifying a temperature deviation in combination with a threshold change in the auxiliary acoustic signal, the hydraulic pressure signal, or primary visual signal. This allows the system to automatically adjust the duration of the delay interval in Step (IV), adapting its kinetic management to poor-quality raw materials that would otherwise cause a rapid loss of slump.

In an additional embodiment, the processing unit identifies a correlation between a decrease in the auxiliary electronic signal and an increase in an air content percentage or a deviation in a rheological stability range, adjusting the magnitude of the incremental doses or the rotational speed to maintain the concrete mix within a target stability zone of about 5% to about 7%, or any other desired air content percentage. This multimodal approach optimizes the mechanical energy input to stabilize the air-void system within the concrete matrix.

In another embodiment, the processing unit provides an optional manual processing mode to receive remote decision commands from an external supervisor or local commands from a vehicle driver. In still another embodiment, the processing unit commands the controlled dosing of water to reduce viscosity or to wet aggregates to a minimum workability threshold prior to the introduction of chemical admixtures. In yet another embodiment, the system executes a cement-reduction protocol where the processing unit identifies a reduction in the total content of cement and, optionally, mineral or chemical additives, and commands a corresponding reduction in water content to maintain a target water-to-binder ratio, wherein the dose of water-reducing admixtures is increased in staircase steps until reaching a safety interlock point to prevent segregation or bleeding.

In a distinct embodiment, the system is configured for the production of specialized mixtures including high-strength concrete, 3D-printed concrete, and geopolymer mixtures, as well as formulations with varying slump or flow requirements, wherein the processing unit monitors setting times or non-standard technological requirements including extreme retardation or acceleration.

In another aspect, the invention provides a concrete mixing control system comprising a rotating mixing drum and a sensor assembly housing at least one camera to provide a primary electronic signal. The system further comprises at least one auxiliary sensor selected from a hydraulic pressure transducer, an internal drum pressure sensor, an acoustic sensor, and a temperature sensor. The system further comprises an admixtures delivery system comprising one or more independent reservoirs and a processing unit configured to execute a proactive AI-driven control algorithm for inhibiting and delivering chemical admixtures according to the method of any one of the preceding embodiments.

In a further aspect, the invention provides a concrete production network comprising a stationary batching plant and a plurality of stationary or mobile concrete mixers, wherein the processing unit transmits real-time sensor data from a current mixer to the stationary batching plant to facilitate a predictive recipe correction (redesigning concrete mix components) for a subsequent batch in a delivery sequence. This networked approach facilitates the synchronization of chemical dosing across a fleet based on real-time kinetic signature feedback identifying presence of contaminants, dust, or uncharacteristic hydration states.

In another embodiment, the autonomous cyber-physical production system utilizes the multi-modal data to generate a predictive model of the hydration curve, allowing the processing unit to calculate a projected slump-life window. This enables the APC to preemptively adjust the target material property and staged dosing protocol as a function of predicted workability loss. By proactively modifying the chemical kinetics based on external logistical variables including transit time, ambient temperature at the discharge site, and structural requirements, the system ensures the batch arrives at the final placement area in an optimal state without human intervention.

In still another embodiment, the system executes a sensor-fusion confidence protocol wherein the processing unit assigns a reliability weight to the primary and auxiliary electronic signals based on detected environmental noise. During an initial loading and wetting phase, the auxiliary signal is assigned a higher weight to mitigate the environmental noise, with the primary signal weight being dynamically increased following the identification of the stabilization event.

In yet further aspect, the present invention provides an autonomous cyber-physical production system for the proactive management of concrete production. This system comprises an active hardware matrix and an autonomous processing core (APC). The active hardware matrix includes a rotating mixing drum, a sensory array comprising a camera for visual feedback and at least one auxiliary sensor selected from mechanical, acoustic, or thermal sensors, and an admixtures delivery system.

The autonomous processing core (APC) is in communication with the active hardware matrix and is embodied in a processing unit. This core is configured to execute an integrated command and execution architecture that performs a normalization step on primary and auxiliary electronic signals to isolate material resistance and visual flow characteristics from mechanical variables and concrete volume. The architecture further identifies a stabilization event representing a true material plateau and calculates a dynamic saturation index based on multi-modal signatures to determine a chemical receptivity state. Additionally, the core commands the admixtures delivery system to dispense incremental doses as a function of the deviation between a steady-state baseline and a target material property while monitoring signal noise variance to execute a coefficient of variation (CoV) protocol for homogenization verification.

In some embodiments, a method is provided for the autonomous management of concrete production by the aforementioned cyber-physical production system. The method begins by establishing an integrated command and execution architecture between the sensory array and the admixtures delivery system via the APC. The processing unit then executes a normalization step to index mechanical resistance data and visual flow characteristics against real-time angular velocity and concrete volume to identify a stabilization event representing the conclusion of an initial aggregate absorption phase, contaminant saturation, and initial hydration reactions. Following this identification, the system calculates a dynamic saturation index to predict a chemical receptivity state of the concrete mix.

Chemical admixtures are delivered as incremental doses through the active hardware matrix, wherein the magnitude of each dose is dynamically adjusted as a function of the deviation between a steady-state baseline and a target material property. Finally, the method verifies homogenization by monitoring a coefficient of variation (CoV) of the sensory array feedback until the feedback returns to the steady-state baseline, ensuring feedback stability before subsequent dosing or discharge.

In still another aspect, a non-transitory computer-readable medium comprises programmed instructions that, when executed by a processing unit, cause the processing unit to: sample multi-modal data comprising a visual primary signal and at least one auxiliary electronic signal; normalise the visual primary signal and the at least one auxiliary electronic signal against a rotational speed and a concrete volume; identify a stabilization event representing the conclusion of at least one of an aggregate absorption phase, contaminant saturation, and initial hydration reactions; calculate a dynamic saturation index (DSI) to trigger a control interlock for an admixtures delivery system; and execute a staged dosing protocol of incremental doses wherein each subsequent dose is inhibited until a steady-state baseline is returned in the multi-modal data.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1A is a diagram illustrating the integrated command and execution architecture of the autonomous cyber-physical production system, depicting the logical layers of the autonomous processing core, its interaction with the fleet-level optimization loop, and the control of the active hardware matrix.

FIG. 1B is a hardware architecture of an autonomous cyber-physical production system, illustrating the rotating mixing drum (12) and the placement of a sensor assembly (40) comprising an acoustic sensor (20), a camera (38), and an optional temperature sensor, mounted at a rear access point (36) of the rotating mixing drum (12), in communication with a processing unit (24) and an admixtures delivery system (34).

FIG. 1C is a refined schematic of the processing unit (24) and admixtures delivery system (34), highlighting the internal microprocessor (28), memory (30), and I/O interfaces (32) in communication with independent chemical reservoirs (16a, 16b).

FIG. 1D is a logical signal flow diagram illustrating the closed-loop reactive controller and the interaction between the various sensors (20, 26), processing unit (24), and delivery hardware (34).

FIG. 2 is a logic flowchart illustrating the kinetic management algorithm, depicting the sequence from initial sampling and stabilization detection through to the control interlock during a delay interval and incremental dosing loop.

FIG. 3 is a graph showing the relationship between hydraulic pressure and time, specifically identifying the plateau in the rate of change that triggers the stabilization event.

FIG. 4 is a spectral graph showing the frequency shift in the acoustic signature during the initial aggregate absorption phase and the transition to a homogenized state.

FIG. 5 is an illustration of the staircase dosing protocol executed by the processing unit (24). This graph shows the impact of incremental admixture doses (D) on hydraulic pressure and the subsequent homogenization windows (W) during the chemical introduction phase.

FIG. 6 is a comparative graph illustrating the increase in workability (slump) achieved by the kinetic management algorithm using a delay interval of approximately ten minutes versus immediate admixture introduction at a batching plant.

FIG. 7A is a composite figure illustrating the correlation between moisture content and the corresponding acoustic signature. The figure includes a graph showing acoustic stabilization plateaus for relatively dry, semi-dry, and wet aggregates, paired with corresponding visual panes.
FIG. 7A-1 is a photographic image, captured by a camera, of the concrete mix obtained from the dry aggregate (1.35% moisture).
FIG. 7A-2 is a photographic image, captured by a camera, of the concrete mix obtained from the semi-dry aggregate (2.15% moisture).
FIG. 7A-3 is a photographic image, captured by a camera, of the concrete mix obtained from the wet aggregate (4.65% moisture).

FIG. 7B is a graph illustrating the correlation between aggregate moisture content and the resulting thermal profile of the concrete mix over time, providing a thermal fingerprint for moisture state validation. The curves represent the initial temperature states and hydration-driven temperature rises for 4.65%, 2.15%, and 1.35% moisture levels.

FIG. 8 is a graph illustrating the hydration-driven temperature rise of a concrete mixture over time and the determination of a thermal stabilization event. The graph compares temperature curves for various chemical addition protocols and identifies a late addition window for the introduction of chemical components, specifically retarder (RE) and water reducer (WR), to optimize concrete workability.

FIG. 9 is a comparative bar chart illustrating the final concrete slump (mm) achieved after 60 minutes for different chemical addition protocols, demonstrating the workability optimization achieved by the kinetic management system through precisely timed delayed additions of retarder and water-reducing components.

FIG. 10 is a comparative bar chart illustrating the mixer power consumption for various chemical addition protocols, demonstrating the reduction in mechanical resistance and energy usage achieved through the kinetic management system.

FIG. 11 is a schematic view of a concrete mixer interior, illustrating the visual analysis parameters, such as flow angle and vortex depth, used by the processing unit to verify concrete slump and workability state.

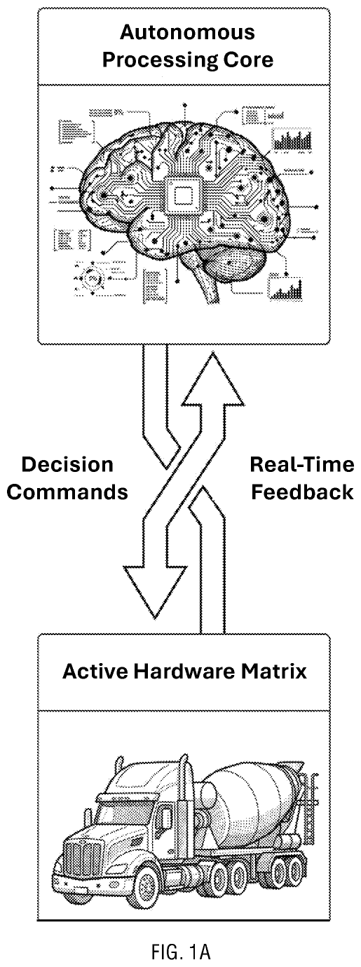

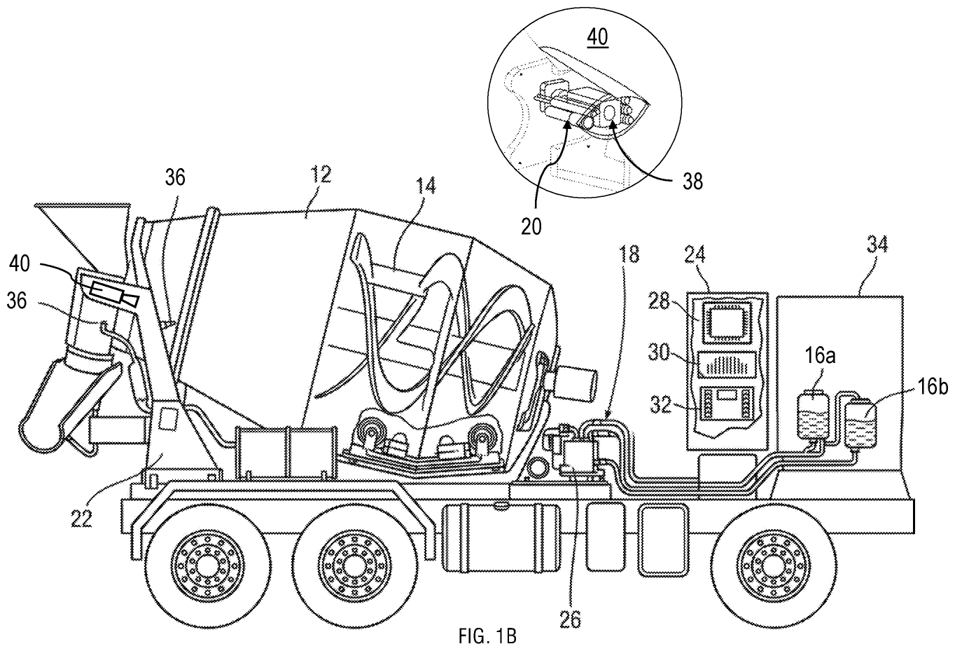

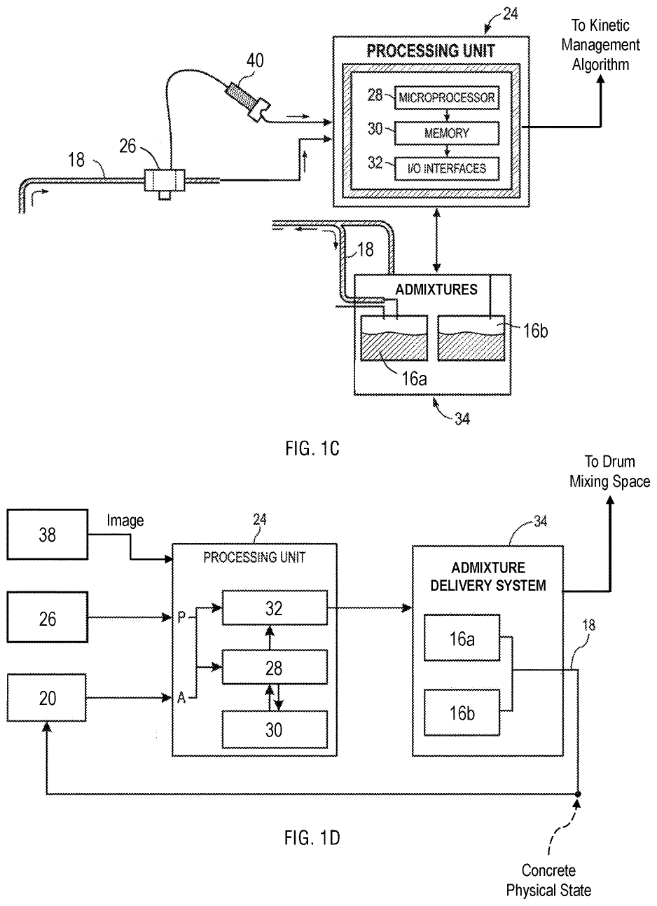

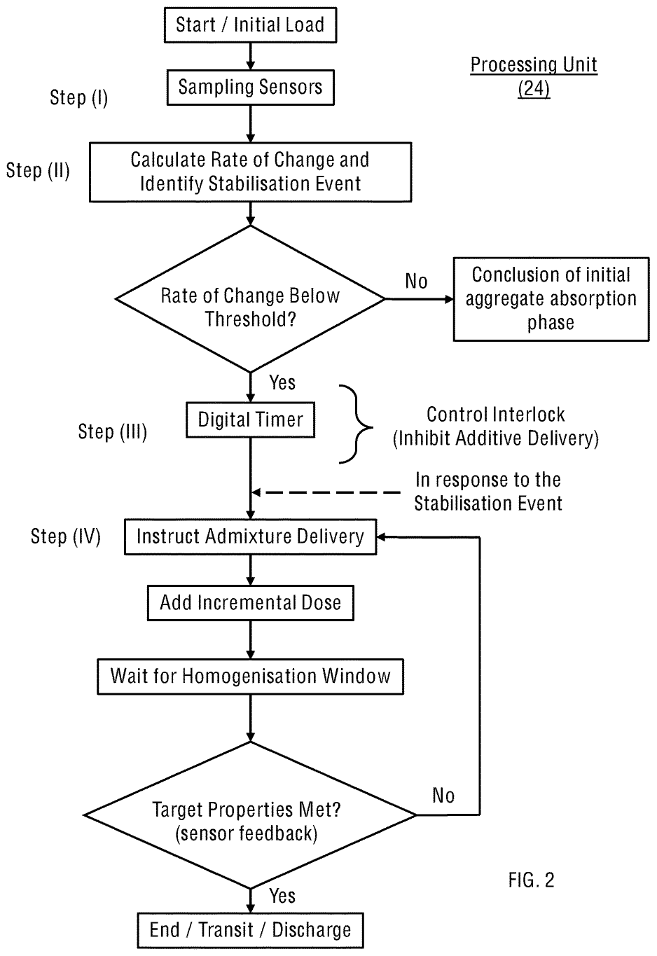

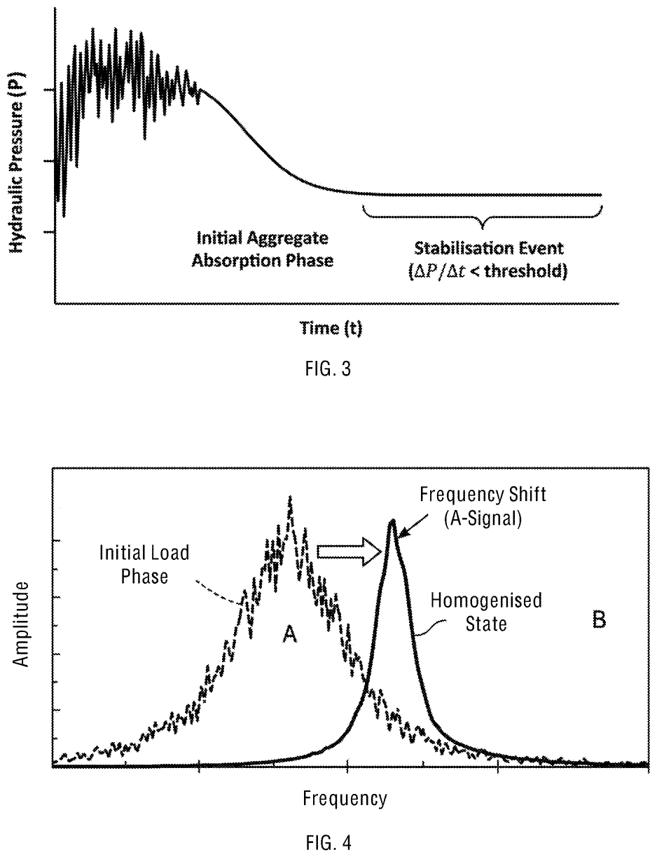

FIG. 12 is a graphical representation illustrating the mechanical effects of the late addition protocol within a concrete mixer. The figure comprises a power consumption graph that contrasts a traditional immediate chemical addition protocol with the kinetic management protocol to demonstrate the reduction in mixing resistance achieved through delayed addition.
FIG. 12-1 is a photographic image, captured by a camera, of the concrete mix during the initial aggregate absorption phase. The image illustrates the stiff, high-friction state of the mix that corresponds to the initial peak on the power graph.
FIG. 12-2 is a photographic image, captured by a camera, of the concrete mix following the execution of the late addition protocol. The image visually confirms the transition to a fluid state and the achievement of target workability.
FIG. 12-3 is a photographic image, captured by a camera, of the concrete mix under a traditional initial loading condition. The image provides a visual contrast to the optimized state, showing the poor workability, poor stiff consistency, segregation and bleeding that persist when the admixture is added without kinetic management logic.

FIG. 13 is a logic flowchart illustrating the operational steps performed by the processing unit to identify the moisture state, detect the thermal stabilization event, and execute the timed release of chemical components.

FIG. 14 is a comparative bar chart illustrating the effect of water-reducer addition timing on the final concrete slump, specifically highlighting the workability loss associated with simultaneous chemical admixtures addition due to competitive adsorption of the chemical components.

FIG. 15 is a graph illustrating hydration-driven temperature profiles of concrete mixtures subjected to different chemical addition sequences, comparing a simultaneous addition protocol with a staged kinetic management protocol to identify the thermal signature of chemical interference and its correlation to concrete workability.

FIG. 16A is a graph illustrating the correlation between mixer power consumption and rotation speed (rpm) for various concrete slump levels, demonstrating the use of power as a real-time workability proxy.

FIG. 16B is a graph illustrating the correlation between acoustic signature (dB) and rotation speed (rpm) for various concrete slump levels, providing a multi-modal verification of the workability state.

FIG. 17A is a comparative bar chart and visual representation illustrating the workability performance of lignosulfonate (LS) based admixtures, contrasting traditional initial loading conditions with the 7-minute late addition window protocol.

FIG. 17B is a comparative bar chart and visual representation illustrating the workability performance of naphthalene sulfonate (NS) based admixtures, contrasting traditional initial loading conditions with the 5 to 10-minute late addition window protocol.

FIG. 18A is a graph illustrating the real-time power consumption of the mixer during a lignosulfonate (LS) addition event, showing the immediate reduction in mechanical resistance upon timed chemical release.

FIG. 18B is a graph illustrating hydration-driven temperature profiles of concrete mixtures using lignosulfonate (LS) based admixture, comparing initial loading with a staged kinetic management protocol to identify the thermal signature of chemical efficacy duration.

FIG. 19A is a graph illustrating an optimization loop through an incremental dosing protocol, depicting a controlled staircase reduction in mixer power as the concrete reaches a target workability plateau. The curve illustrates the staircase progression where the processing unit achieves target workability through a series of seven distinct, small-volume chemical additions, proving the system can precisely hit a target without overshooting.

FIG. 19B is a graph illustrating an optimization loop through an incremental dosing protocol, depicting a controlled staircase reduction in mixer power as the concrete reaches a target workability plateau. The system also shows a state of mixture breakage accompanied by segregation and water bleeding.

FIG. 20 is a comparative bar chart illustrating the reduction in raw materials (water and cement) and the increase in workability (slump) achieved through a carboxylate-based staged addition protocol compared to a traditional mix. This chart visually confirms the massive efficiency gains.

FIG. 21A is a graph illustrating the real-time power consumption of the mixer during the processing of high-absorption aggregates, depicting the multi-stage chemical addition protocol used to stabilize concrete workability.

FIG. 21B is a graph illustrating the thermal inversion signature associated with high-absorption raw materials, showing the temperature drop that triggers the specialised kinetic management protocol.

FIG. 22 is a comparative grouped bar chart illustrating the performance metrics for concrete produced with high-absorption aggregates, contrasting staged kinetic production with traditional production across water-to-cement ratio, workability, and compressive strength.

FIG. 23A is a comparative bar chart illustrating concrete workability (slump) as a function of addition timing, demonstrating the technical advantage of delaying the introduction of chemical components.

FIG. 23B is a comparative bar chart illustrating concrete workability as a function of the chemical addition sequence, providing empirical evidence of the synergistic performance achieved through the staggered introduction of water-reducing and retarding components.

FIG. 24A is a graphical representation illustrating the inverse relationship between mixer power and air content of the fresh concrete, utilized by the processing unit to monitor the mechanical resistance of air entrainment within the concrete mix.

FIG. 24B is a graph illustrating air content stability over time, contrasting a traditional production mix with a kinetic management protocol to demonstrate the maintenance of a target air-void system within a stability target zone.

FIG. 24C is a graph illustrating the correlation between air content stability, addition timing, and mixer rotational speed (RPM), demonstrating the synergistic effect of low-energy mixing and staged chemical introduction on the maintenance of a stable air-void system.

FIG. 24D is a graphical representation illustrating the direct correlation between mixer power and the specific weight of the fresh concrete mix, providing a multi-modal cross-validation metric used by the system to distinguish workability improvements caused by chemical liquefaction from those caused by air entrainment. This figure is a pair to FIG. 24A, allowing the processing unit (24) to cross-reference mechanical resistance with material density to verify air content stability and overall mix consistency.

FIG. 25A is a schematic graph illustrating a diagnostic signature for a safety interlock protocol, depicting the simultaneous erratic power consumption drop and noise signature spike associated with concrete segregation and the loss of mixture cohesion.

FIG. 25B is an empirical graph illustrating the identification of a mixture breaking point during a cement reduction protocol, depicting real-time erratic power consumption signatures associated with concrete segregation and bleeding, caused by non-optimal chemical addition. This figure provides the technical basis for a safety interlock claim, allowing the system to detect bleeding and segregation in real time to prevent the delivery of ruined batches.

FIG. 25C is a composite technical illustration comprising a power consumption graph and corresponding photographic images illustrating the mechanical and visual effects of a multi-stage admixture protocol on concrete workability. The figure shows the progression from an initial state through a slump reduction phase to a final stabilized state achieved by a secondary corrective addition of water reducer.

FIG. 26 is a graph illustrating long-term workability retention, contrasting the power consumption rise of a traditional production mix with the stabilized flow plateau achieved through a kinetic management protocol over a 40-minute duration.

FIG. 27 is a system architecture diagram illustrating the fleet-level optimization loop, depicting the communication between a stationary batching plant and multiple batch mixers through a central processing unit to implement real-time recipe corrections for subsequent batches.

FIG. 28 is a composite schematic diagram illustrating the transition from macroworld monitoring to microworld monitoring within the kinetic management protocol. The upper portion of the figure depicts macroworld monitoring through the observation of bulk physical parameters such as mix temperature and drum speed of a rotating concrete drum. The lower portion provides a detailed technical view into the cement matrix representing microworld monitoring of microscopic processes, including the adsorbed admixture layer, the hydration layer, and surface charge interactions at the cement particle surface. The figure demonstrates how the processing unit (24) utilizes molecular level data to proactively predict the chemical state of the concrete mix instead of relying solely on raw physical parameters.

FIG. 29 is a comparative schematic diagram illustrating the physical principles of particle adsorption and molecular lubrication within a concrete mix. The upper portion of the figure depicts a standard mix on a macro-scale characterised by high internal friction and mechanical resistance caused by the clumping of cement particles. The lower portion of the figure illustrates the effect of the kinetic management protocol where a chemical admixture forms a lubrication layer around individual cement particles at a molecular level. This managed state minimises inter-particle friction to achieve a reduction in the torque and power requirements of the mixer drum as determined by the processing unit (24).

FIG. 30 is a graphical representation providing a torque requirement comparison between a standard concrete mix and a mix managed by the kinetic management protocol. The graph plots the torque and energy requirements of the mixer drum in Newton-meters as a function of mixing time in minutes. A first data curve representing a standard mix illustrates the high and erratic torque levels required to rotate the load due to significant internal friction between clumping particles. A second data curve representing a Sensolyzer™ controlled mix illustrates a stabilized and significantly lower torque profile achieved through the application of molecular lubrication. The vertical displacement between the two data curves demonstrates the sustainable energy gain and reduced fuel or electricity consumption achieved by the system.

### DEFINITIONS

The term ‘comprising’, used in the claims, is ‘open ended’ and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a method comprising steps x and z” should not be limited to methods including only steps x and z. The scope of the expression “a system comprising x and z” should not be limited to systems consisting only of components x and z.

Unless specifically stated, as used herein, the term ‘about’ is understood as within a range of normal tolerance in the art, for example within two standard deviations of the mean. In one embodiment, the term ‘about’ means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value.

In other embodiments, the term ‘about’ can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum.

Unless otherwise clear from context, all numerical values provided herein are modified by the term ‘about’. Other similar terms, such as ‘substantially’, ‘generally’, ‘up to’ and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term ‘and/or’ includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

In the field of concrete engineering and industrial production, a “traditional mix” refers to the standard batching procedure where all primary constituents, including cement, water, fine and coarse aggregates, and chemical admixtures, are introduced and combined at the commencement of the mixing process. This typically takes place at a central stationary plant or during the initial loading of a transit mixer, where the proportions are governed by a predetermined recipe and static batching weights.

A defining feature of the traditional mix is the simultaneous introduction of chemical agents, such as water reducers or retarders, alongside the batching water. Because these components are integrated at the beginning, the chemical interaction with the cement particles initiates immediately. While this provides a known baseline for workability, it does not account for the dynamic changes that occur during the hydration process or the impact of environmental factors during transportation. Consequently, traditional mixes are often subject to slump loss, where the fluidity of the concrete decreases over time, potentially necessitating the addition of water on-site, which can compromise the structural integrity and design strength of the final product.

In technical research and experimental validation, the traditional mix is utilized as the primary control sample. It establishes the baseline sensory and physical data for a specific concrete grade under standard operating conditions. By comparing the results of a traditional mix against modified protocols, such as staged dosing, incremental separation, or automated kinetic management, engineers can objectively measure and verify improvements in chemical efficacy, water reduction, and overall workability. This comparative analysis is fundamental to demonstrating the technical superiority and efficiency of advanced production methodologies.

As used in the present disclosure, the term “macroworld monitoring” refers to the observation of bulk physical parameters, such as mix temperature and drum speed. In contrast, “microworld monitoring” refers to the real-time observation of microscopic processes at the surface of cement particles, such as particle adsorption and hydration layer formation. By monitoring the microworld, the system manages the formation of a molecular lubrication layer around individual cement particles. This managed state minimizes internal friction between particles to achieve a reduction in torque and energy consumption compared to a traditional mix.

As defined in the present invention, the term “autonomous cyber-physical production system” refers to an integrated system where an “autonomous processing core” (APC) and an “active hardware matrix” function as a cohesive unit, such as a smart concrete truck or a smart concrete mixer, to manage the concrete production cycle.

The “active hardware matrix” or “physical execution assembly” serves as a hardware body, comprising hardware components and mechanisms, sensory array, and admixture delivery system. Together with an autonomous processing core, the active hardware matrix forms the cohesive unit, such as a smart concrete truck or a smart concrete mixer, that enables the system to observe, decide, and act entirely on its own, without human intervention by simulating human intuition with quantitative precision. The term “admixture delivery system” refers to a hardware assembly comprising at least one reservoir, a pump or gravity-fed valve, and delivery lines configured to dispense specific volumes of chemical admixtures upon receipt of a command from the processing unit.

In the context of the present invention, the terms “autonomous processing core” and “processing unit” refer to the same primary component but from different perspectives. Within the context of the present disclosure, the autonomous processing core (APC) is the functional and logical descriptor used to establish the system as an autonomous agent, representing the digital brain of the system that executes high-level predictive logic and decision-making.

The “processing unit” is an electronic device comprising at least one microprocessor or microcontroller capable of executing a set of programmed instructions stored in a non-transitory memory. The processing unit is specifically configured to sample high-frequency electronic signals from sensors, perform real-time mathematical operations, and transmit control commands to peripheral hardware such as the admixture delivery system.

In other words, the processing unit is the specific structural term used in the present invention to identify the physical hardware assembly. This hardware assembly includes the internal microprocessor, memory, and input-output (I/O) interfaces that facilitate the communication between the sensor array and the admixture delivery system. While the “processing unit” is the formal term identifying a physical part of the system, the “autonomous processing core” (APC) is the terminology used to define its role within the integrated command and execution architecture.

The term “sensory array” comprises a plurality of transducers configured to provide multi-modal feedback to the processing unit. This array includes a hydraulic pressure transducer fluidly coupled to the hydraulic lines of a hydraulic motor driving the rotating mixing drum, as well as any other pressure-sensing device, such as a load cell, a strain gauge, or a torque meter, submerged within the drum and/or positioned externally on the drive assembly. The sensory array further includes a sensor assembly mounted on a support frame adjacent to the rotating mixing drum, wherein said sensor assembly houses an acoustic sensor and a camera.

The term “hydraulic pressure transducer” refers to a physical sensor fluidly coupled to the hydraulic lines of a hydraulic motor driving the rotating mixing drum. This term also encompasses any other pressure transducer or force-sensing device, such as a load cell, a strain gauge, or a torque meter, positioned either internally within the mixing drum or externally on the mechanical supports and drive assembly. These sensors are configured to convert the mechanical pressure of the hydraulic fluid into an electronic signal proportional to the torque required to rotate the concrete mix.

Similarly, an “acoustic sensor” refers to a transducer, such as a microphone or an accelerometer, configured to detect mechanical vibrations or sound waves. This sensor is mounted on a non-rotating pedestal or support frame of the concrete mixer to capture the acoustic signature generated by the internal movement and impact of the concrete mix against the internal surfaces of the rotating mixing drum.

As used herein, a “rotational speed sensor” is a transducer, such as an encoder or a magnetic pickup, configured to measure the angular velocity (RPM) of the rotating mixing drum and provide an additional electronic signal to the processing unit. A “temperature sensor” is a transducer configured to measure the thermal profile of the fresh concrete mix and provide a temperature signal.

The term “sampling” defines the discrete acquisition of data points from an analog or digital electronic signal at a predetermined frequency or sampling rate. In the context of this invention, sampling occurs at a frequency sufficient to capture the transient changes in hydraulic pressure and acoustic signatures within a single revolution of the rotating mixing drum.

As used herein, the term a “normalization step” refers to a mathematical safeguard where the processing unit indexes both the primary electronic signal (visual data) and the auxiliary electronic signals against real-time angular velocity data from the rotational speed sensor and the concrete volume. Because concrete is a non-Newtonian, shear-thinning fluid, its apparent viscosity and visual flow characteristics are dependent on the shear rate. The normalization step isolates the material's physical resistance and kinetic state from mechanical variables such as fluctuations in engine load or drum RPM to ensure that a stabilization event represents a true physical plateau of the material state.

The mathematical concept of “rate of change” defines the derivative of the sampled electronic signals over time. In the computer-implemented algorithm, this is calculated as a moving average of the difference between consecutive samples divided by the sampling interval, representing the velocity of physical or chemical change within the mix.

A “stabilization event” refers to a mathematically defined state where this rate of change of the normalized primary and auxiliary signals reaches a plateau. The processing unit identifies this event when the variance or standard deviation of the signals remains within a predetermined threshold, such as less than 2.5 percent, for a specified duration. This state represents the conclusion of the initial aggregate absorption phase, contaminant saturation, and initial hydration reactions.

The “initial aggregate absorption phase” refers to the stage where dry or semi-dry aggregates physically absorb a portion of the batch water and chemical admixtures into their internal pore structure. “Contaminant saturation” refers to the point where clay or dust particles have reached a saturation state, and initial hydration reactions refer to the violent initial kinetic phase of the cementitious components.

As used herein, the term “triple-event plateau”, also referred to as “triple-event stabilization”, defines a specific stabilization event identified by the APC that marks a critical state of kinetic readiness and chemical receptivity in a fresh concrete mix. This plateau signifies the simultaneous conclusion of three distinct physical and chemical transitions:
(i) the initial aggregate absorption phase, where dry or semi-dry aggregates physically sequester batch water and chemical admixtures into their internal pore structure;
(ii) the contaminant saturation point, where clay, dust, or other contaminants reach a state of hydration equilibrium; and
(iii) the stabilization of initial hydration reactions involving the aluminate and ferrite components, specifically tricalcium aluminate (C₃A) and tetracalcium aluminoferrite (C₄AF).

The triple-event plateau is mathematically identified when the rate of change (ΔP/Δt) of normalized multi-modal signals, including visual, hydraulic, and acoustic data, reaches a steady-state plateau. This state provides empirical proof that the physical wetting process is complete and that the mix has achieved baseline physical homogeneity. By identifying this equilibrium state, the system ensures that subsequently introduced chemical admixtures act primarily on the cement paste to maximize effectiveness while preventing the permanent loss of chemical efficacy through sequestration within aggregate pores

The term “visual kinetic markers” refers to identifiable geometric features or textures on the surface of the concrete mix, such as aggregate edges, mortar streaks, or slurry highlights, which the APC tracks frame-to-frame to calculate real-time flow velocity and turbulence. “Flow patterns” refers to the macro-geometric structure of the mix within the rotating drum, specifically the depth of the central vortex and the specific angle of the rolling wave of concrete as it cascades over the internal vanes.

A “material variable” comprises physical or chemical characteristics of the raw materials that alter their interaction with water and admixtures. This includes, but is not limited to, aggregate porosity and absorption capacity, aggregate density, pore size and volume, particle size distribution, the concentration of clay, organic matter, or dust contaminants, and the specific chemical composition of the cement, such as its fineness, ratio of aluminate and ferrite phases to silicate phases, and the initial temperature and moisture content of the raw materials.

The “operational window” refers to the total duration of time during which the concrete mix remains in a workable, fluid state suitable for its intended application. The projected operational window is a calculated timeframe generated by the APC that accounts for the hydration kinetics of the specific mix design and external environmental factors, representing the remaining time until the mix reaches its setting point.

A “final placement” refers to the act of depositing the concrete into its permanent structural form, such as a mold, shuttering, or a 3D-printing layer. A discharge event refers to the physical removal of the concrete mix from the rotating mixing drum, whether into a pump, a skip, or directly into a placement area.

A “predictive recipe correction” (redesigning concrete mix components) is a proactive adjustment made to the proportions of a subsequent concrete batch at a stationary plant. This correction is based on the real-time kinetic signature of a previous batch, allowing the plant to preemptively compensate for stability and performance changes arising from factors including: (1) aggregate absorption; (2) the presence of contaminants such as clay, organic matter, and dust; (3) chemical processes including cement hydration and reactions of mineral additives; (4) chemical and physical neutralization of admixtures by contaminants; (5) changes in ambient temperature and humidity; (6) elapsed transit and mixing time; (7) raw material temperature; (8) raw material moisture content; (9) cement fineness and chemical composition; (10) particle size distribution of aggregates; (11) aggregate density and porosity characteristics, including pore size and volume; and (12) total water content and admixture dosage percentages.

A “dynamic saturation index” (DSI) refers to a calculated readiness score derived from multi-modal signatures, including hydraulic, thermal and acoustic signatures. Unlike a fixed timer, this index dynamically predicts when the mix is chemically receptive to admixture introduction based on the real-time kinetic state of the hydration process.

The term “staged dosing protocol” refers to a managed sequence of chemical delivery determined by the APC as a function of the mix type and the projected operational window. This protocol utilizes the steady-state baseline to quantify required volumes and navigate the material toward a target state.

The term “incremental doses” refers to a dosing strategy where a total required volume of chemical admixture is divided into smaller, discrete portions, each representing a mass percentage between about 0.1 percent and about 0.5 percent relative to the total cement weight. The term “homogenization” defines the process of making a mixture uniform in composition and structure. While dispersion is a necessary step to achieve homogenization, the latter implies a more intensive level of mixing to ensure that any small sample of the mixture is identical to any other sample.

A “homogenization window” stands for a mechanical requirement for the sensor feedback loop, serving as a mandatory wait time of at least three revolutions following any single dose to allow the admixture to be physically integrated into the bulk mass. This ensures the processing unit can accurately measure the new state of the concrete before deciding whether to trigger a subsequent dose, thereby acting as a tool for feedback stability.

The “coefficient of variation” (CoV) protocol refers to a homogenization verification method that monitors signal noise in the hydraulic, visual, or acoustic data. Rather than relying on a fixed number of revolutions of the rotating mixing drum, the system calculates the variance in the sensor feedback following a dose. A subsequent dose is only triggered when the noise returns to a steady-state baseline, confirming that the prior dose has fully integrated into the bulk mass. This prevents the formation of localized chemical hot spots and ensures feedback stability.

In a rotating concrete drum, the hydraulic pressure signal is never a perfectly flat line but a noisy, oscillating signal due to the vanes lifting and dropping the concrete. To the processing unit, a steady-state value is not just a number, but a statistical derivation. The “steady-state baseline” is therefore defined as the mean value of the auxiliary electronic signal calculated over a sliding window of at least two drum revolutions, wherein the variance of said signal remains below a predefined stability threshold. This statistical derivation accounts for the inherently noisy and oscillating nature of the hydraulic signal. Under this protocol, the APC does not interpret a steady-state value as a single static number but as a calculated stabilization of the mechanical resistance over time.

The term “environmental noise” refers to transient sensory interference or background signals generated by external factors during the concrete production and transit process, which may include, without limitation, dust concentrations, atmospheric conditions, moisture variations, mechanical vibrations from the vehicle engine or drum drive, or visual and acoustic obstructions within the mixing environment. This noise is mathematically isolated, filtered, or weighted by the APC to maintain the reliability of the multi-modal feedback loop.

The “sensory reliability weighting protocol” defines a logic state where the processing unit dynamically shifts the priority of different sensor inputs based on the production phase. During the initial loading phase characterized by high environmental noise, the system assigns a higher reliability weight to the auxiliary hydraulic or acoustic signals. During the transit and stabilization phases, the system increases the weighting of visual signatures as environmental conditions clear.

The term “target material property” refers to a technical placeholder defining a desired physical or chemical state of a concrete mix as established in an operator-defined configuration stored in the memory. This term encompasses a comprehensive set of parameters including workability, air content percentage, specific weight, water-to-binder ratio, and compressive strength. The target material property serves as a numerical set-point utilized by the APC to perform real-time deviation calculations and execute proportional adjustments of incremental doses.

A “digital timer” defines a software-based or hardware-based time counting mechanism within the processing unit that measures a specified duration of time following a trigger event. The term “control interlock” refers to a logical or physical constraint executed by the processing unit that prevents a specific action from occurring until a set of conditions is met. In the present invention, the control interlock maintains the admixture delivery system in a deactivated state regardless of external inputs until the DSI countdown has expired.

A designated “chemical-separation interval” defines a chemical requirement for admixture efficacy. This is a specific strategic delay inserted between the introduction of two different chemical species, such as a polycarboxylate and a sodium gluconate, to ensure the first component has successfully adsorbed onto the cement grains before the second is introduced. The homogenization window ensures the sensors are reading a uniform mix, while the chemical-separation interval ensures the chemicals do not interfere with one another.

A “mixture breaking point” refers to a critical threshold where the mixture loses structural cohesion, resulting in segregation and bleeding. This state is characterized by a rapid downward spike or a drop in hydraulic pressure in the auxiliary electronic signal and by breaking point visual markers, which include the downward flow of cementitious paste from the upper vanes of the drum and the formation of a static water layer on the concrete surface. The term “safety interlock” refers to an autonomous self-preservation protocol executed by the processing unit to protect the structural integrity of the final concrete product by inhibiting discharge when a breaking point is detected.

The term “chemical receptivity state” refers to a mathematically predicted temporal window within the concrete production cycle where the cement particles are physically and chemically available for the molecular adsorption of admixtures. This state is identified by the APC following the conclusion of the initial aggregate absorption phase, contaminant saturation, and initial hydration reactions. Within the microworld of the concrete mix, this state represents the moment where the internal pore structure and chemical kinetic spikes have reached a saturated or stabilized state. Reaching the chemical receptivity state is a prerequisite for executing the staged dosing protocol, as it ensures the admixtures can effectively form a molecular lubrication layer around the cement particles.

### DETAILED DESCRIPTION OF THE INVENTION

In the following description, various aspects of the present application will be described. For purposes of explanation, specific details are set forth in order to provide a thorough understanding of the present application. However, it will also be apparent to one skilled in the art that the present application may be practiced without the specific details presented herein. Furthermore, well-known features may be omitted or simplified in order not to obscure the present application.

As illustrated in FIG. 1A, the autonomous cyber-physical production system functions through the integration of an autonomous processing core (APC) embodied in a processing unit and an active hardware matrix. In this architecture, the APC serves as the functional and logical brain of the system, executing high-level predictive logic based on the perceived physical reality of the concrete mix. The active hardware matrix acts as the physical body or execution assembly, comprising the rotating mixing drum, the sensory array, and the admixtures delivery system.

This closed-loop framework enables the system to observe the microworld kinetics of the cement matrix and implement proactive control actions entirely on its own. By simulating human intuition with quantitative precision, the APC ensures that the chemical receptivity state of each batch is identified and managed without requiring manual intervention to maintain the workability plateau.

Reference is made to FIG. 1B, schematically showing the autonomous cyber-physical production system comprising an active hardware matrix, also referred to as a physical execution assembly, which serves as the physical body of the system and is integrated with the autonomous processing core (APC) to manage the production and stabilization of fresh concrete. The primary structural component of the active hardware matrix is a rotating mixing drum (12) mounted on a support frame (22). In mobile applications, the support frame (22) is part of a vehicle chassis, while in stationary applications, such as precast plants or 3D-printing stations, the support frame (22) is a fixed industrial structure.

The rotating mixing drum (12) includes a plurality of internal vanes (14) arranged in a helical pattern to lift and drop the concrete mix during rotation. The geometry and orientation of these vanes ensure that the concrete mix is subject to continuous mechanical energy, which is essential for homogenization. The mechanical rotation of the drum is driven by a hydraulic motor drive assembly fluidly coupled to the drum (12) through high-pressure and low-pressure hydraulic lines (18). The hydraulic system provides the necessary torque to rotate the concrete mass, which may weigh several tons depending on the batch volume.

The active hardware matrix further comprises a hydraulic pressure transducer (26) fluidly coupled to the hydraulic lines (18). The hydraulic pressure transducer (26) is configured to detect the mechanical resistance encountered by the vanes (14) as they move through the concrete mix. This mechanical resistance is converted into an auxiliary electronic signal proportional to the torque, which the APC utilizes to calculate mechanical resistance variance and identify the stabilization plateau of the mix. In alternative configurations, the active hardware matrix may utilize other mechanical resistance sensors, such as load cells, strain gauges, or torque meters, positioned on the drive assembly and/or submerged within the drum.

As described in the earlier disclosures of the inventor, specifically U.S. Patent Publication No. 20250375922 A1, the entire disclosure of which is incorporated herein by reference, the active hardware matrix further comprises a protected sensor assembly (40), which is mounted on the support frame (22) adjacent to the rear access point (36) of the rotating mixing drum (12). The sensor assembly (40) is specifically oriented to provide a clear line of sight into the interior of the drum. The sensor assembly (40) houses a primary camera (38) and an acoustic sensor (20). The camera (38) is configured to capture high resolution visual data of the concrete surface as a primary electronic signal. This visual data allows the APC to extract visual kinetic markers and flow patterns, such as the vortex depth and flow angle, which serve as proxies for the viscosity and yield stress of the material.

The acoustic sensor (20), which may be a microphone or an accelerometer, is configured to capture the acoustic signature generated by the impact of the concrete mix against the internal surfaces of the drum. This acoustic signature is sampled by the processing unit as part of the multi-modal data loop. The sensor assembly (40) includes a robust housing designed to withstand the harsh environment of concrete production. The housing may be equipped with air purging mechanisms, high pressure water jets, or mechanical shutters to ensure that the lens of the camera (38) and the acoustic transducer remain free from environmental interference, which may include, without limitation, dust, cement slurry, moisture variations, or other visual and acoustic obstructions within the mixing environment particularly during the initial loading and high energy mixing phases.

The active hardware matrix also includes a rotational speed sensor and a temperature sensor. The rotational speed sensor, such as an encoder or magnetic pickup, measures the angular velocity (RPM) of the drum (12), which is essential for the normalization of the visual and mechanical signals. The temperature sensor is positioned to monitor the thermal profile of the fresh concrete mix, providing data that allows the APC to identify exothermic hydration peaks and calculate the kinetic state of the cementitious components, specifically the aluminate and ferrite phases such as tricalcium aluminate (C₃A).

Furthermore, the active hardware matrix includes an admixtures delivery system (34) which functions as the physical execution mechanism for the APC. The admixtures delivery system (34) comprises at least one independent reservoir (16a, 16b) configured to store liquid chemical admixtures, such as water reducing agents, retarders, accelerators, or air entraining agents. Each reservoir is connected to a delivery line equipped with a pump mechanism, such as a peristaltic pump or a diaphragm pump, and a flow meter. The admixtures delivery system (34) is electronically coupled to the processing unit (24), allowing the APC to command the precise injection of chemical volumes into the rotating mixing drum (12). This integrated hardware matrix ensures that the physical introduction of chemical admixtures is synchronized with the chemical receptivity state of the concrete mix as determined by the multi-modal feedback loop.

In specific embodiments for 3D-printing or geopolymer production, the active hardware matrix may include additional reservoirs for chemical activators or setting modifiers that are introduced immediately prior to the final placement or discharge event. The coordination between the sensory array and the admixtures delivery system (34) within the active hardware matrix allows the system to function as a closed loop production environment that adapts to the unique material variables of each batch without human intervention.

FIG. 1C shows the expanded hardware schematic of the processing unit (24), where the APC comprises a microprocessor (28), a non-transitory memory (30) for storing the kinetic management algorithm, operator-defined configurations and programmed instructions, and various input-output (I/O) interfaces (32) for receiving multi-modal sensor data and transmitting control commands. The processing unit (24) is operatively connected to an admixtures delivery system (34) comprising one or more independent reservoirs, identified as a first chemical reservoir (16a) and a second chemical reservoir (16b).

These reservoirs store disparate chemical admixtures, such as water reducers (for example, polycarboxylate (PCE), lignosulfonates and naphthalene sulfonates), retarders (for example, sodium gluconate), accelerators or air-entraining admixtures. By maintaining independent reservoirs (16a, 16b), the system can execute a chemical-separation interval to prevent competitive adsorption and molecular interference. Furthermore, the system may comprise a water reservoir configured to dispense water into the concrete mixture as required.

FIG. 1D illustrates the integrated command and execution architecture, demonstrating the causal signal flow that allows the system to function as a closed-loop reactive controller. The processing unit (24) acts as a central hub featuring a logical compare block that receives multi-modal inputs, including the hydraulic pressure signal (P), the acoustic signal (A), and visual data from the camera (38). The microprocessor (28) utilizes these inputs to calculate a real-time deviation between the current material state and a target material property. This architecture enables the system to observe the microworld of the concrete mixture and, based on the perceived physical reality rather than a static time-based model, determine proactive control actions such as initiating an incremental dose or maintaining a control interlock state.

Reference is now made to FIG. 2, which illustrates the master control logic and the kinetic management algorithm executed by the APC. The flowchart defines the decision-making framework that transforms the raw data from the sensors into precise dosing commands.

The method of the present invention begins with an initial weighting phase that occurs during the raw material loading and wetting stage. During this high-noise period, the processing unit (24) acting as the autonomous brain of the system executes a sensory reliability weighting protocol. Because the internal environment of the rotating mixing drum (12) is often obscured by high levels of environmental noise during the introduction of dry cement and aggregates, the processing unit (24) assigns a higher reliability weight to the hydraulic pressure transducer (26) while down-weighting the visual data from the camera (38).

This proactive weighting ensures that the initial identification of mechanical resistance is grounded in high-fidelity torque data, preventing the system from being blinded by the transient environmental noise typical of the early mixing stage. Once the stabilization event is identified and the environment clears, the processing unit (24) dynamically shifts the reliability weight back towards the visual and acoustic signatures to enable high-resolution monitoring of the chemical receptivity state.

Following the initial weighting phase, the method proceeds to Step (I), which comprises the continuous multi-modal sampling of the fresh concrete mixture. Upon the loading of raw materials into the rotating mixing drum (12), the concrete enters the initial aggregate absorption phase where dry aggregates sequester a significant portion of the batch water. In Step (I), the processing unit (24) actively samples multi-modal data comprising a primary electronic signal including visual data from a camera (38) and one or more auxiliary electronic signals selected from a group consisting of a hydraulic pressure signal (P) from the hydraulic pressure transducer (26), an acoustic signal (A) from the acoustic sensor (20), a temperature signal from a temperature sensor, and a rotational speed signal from a rotational speed sensor. This comprehensive data collection establishes the multi-modal sensory baseline required for the autonomous processing core (APC) to monitor the internal hydration energy and physical state of the mixture.

Step (II) constitutes a vital technical safeguard of the invention, wherein the system performs a normalization step on the data sampled in Step (I) to isolate material resistance from mechanical fluctuations. Because concrete is a non-Newtonian, shear-thinning fluid, its apparent viscosity decreases as the shear rate or rotational speed increases. Therefore, in a revolving mixing drum (12), the hydraulic pressure is not a direct measure of viscosity but a measure of the torque required to rotate the drum (12) at a specific angular velocity.

To ensure the stabilization event represents a true material plateau, the processing unit (24) indexes the hydraulic and visual data against real-time RPM data and the volume of concrete in the drum. This normalization protocol creates a high-fidelity dataset that isolates the physical resistance of the material from engine load fluctuations or speed variations. The resulting signal provides the mathematical basis for calculating the rate of change (ΔP/Δt), which serves as a kinetic proxy for the internal absorption state of the aggregates.

The algorithm in Step (II) calculates rate of change ΔP/Δt for this normalized signal. Mathematically, the processing unit (24) computes this using a discrete derivative over a rolling window of n samples:

$$\frac{Δ P}{Δ t} \approx \frac{{P}_{n} - {P}_{n - k}}{{t}_{n} - {t}_{n - k}}$$

During the absorption phase, the rate of change ΔP/Δt exhibits high volatility. As illustrated in the flowchart, the system identifies a stabilization event only when the variance (σ²) of the signal remains below a predetermined threshold, for example σ²<2.5% of the mean pressure, for a specified duration. This stabilization signifies the “triple-event plateau”: the conclusion of the initial aggregate absorption phase, contaminant saturation, and initial hydration reactions. This state confirms that the aggregates have reached a saturation limit, clay or dust contaminants have reached equilibrium, and the initial kinetic spikes of the aluminate and ferrite phases, such as C₃A (tricalcium aluminate) and C₄AF (tetracalcium aluminoferrite), have stabilized into a baseline homogeneity.

Reference is now made to Step (III) of the autonomous management protocol, which comprises a multi-modal correlation step where the processing unit (24) integrates the calculated derivative ΔP/Δt from the normalised hydraulic signal with real-time visual flow characteristics derived from the camera (38). During the initial aggregate absorption phase, the mixture often exhibits erratic visual patterns such as the uneven distribution of moisture and the presence of dry material clusters. The APC utilizes computer vision algorithms to monitor the texture and surface velocity of the mixture. A stabilization event is only confirmed when the mechanical plateau identified in Step (II) occurs simultaneously with a visual transition toward a more uniform and cohesive texture and is cross-validated through real-time image processing of normalized visual kinetic markers and flow patterns from the primary electronic signal.

By correlating these disparate data streams, the system distinguishes between a temporary mechanical fluctuation and the true stabilization of the internal kinetics. For example, a momentary drop in hydraulic pressure caused by a change in drum tilt might mimic a stabilization event. However, if the visual characteristics continue to show unabsorbed water or dry aggregates, the APC will override the hydraulic signal and maintain the control interlock. This cross-validation ensures that the digital timer for the dynamic saturation index (DSI) is only triggered when both the internal torque and the external surface dynamics provide empirical proof of physical homogeneity.

Upon identifying the stabilization event, Step (IV) executes a control interlock to inhibit an admixtures delivery system for a delay interval defined by a dynamic saturation index (DSI). This DSI typically ranges between about 3 and about 30 minutes, with a preferred duration of 10 minutes, and is dynamically adjusted based on the multi-modal data and at least one material variable selected from a group consisting of an aggregate quality, a mix type, and a presence of contaminants to ensure the mixture has reached a chemical receptivity state. Furthermore, the APC is configured to continue adding admixtures as required throughout the entire transport time of the concrete to maintain the target material property.

During this period of the controlled interlock, the admixtures delivery system (34) is electronically inhibited to prevent the sequestration of chemicals within aggregate pores. Even if the target material properties are not met, for example the slump level of the mix is below the target value, the system is still prevented from opening the dispensing valves. This delay is critical to ensure that when the admixtures are eventually introduced, they interact with the cement paste rather than being sequestered inside the pores of the aggregates, which would occur if added during the unstable absorption phase.

In Step (V), following the expiry of the delay interval, the system initiates the staged or incremental staircase dosing protocol. This involves introducing incremental doses, such as about 0.1% to about 0.5% of cement weight, from the admixture delivery system (34). The processing unit quantifies a total required volume of at least one chemical admixture by establishing a steady-state baseline for the normalized auxiliary electronic signals and correlating said baseline with the visual flow or slump characteristics from the primary electronic signal. Following each dose, the system enforces a homogenization window of at least three revolutions of the mixing drum (12). The sequence of incremental doses is calculated as a function of the mix type and a projected operational window until a final placement or discharge event.

During this interval, the processing unit (24) continuously monitors the signal noise variance to execute a CoV protocol, ensuring that each subsequent dose is inhibited until the previous dose has fully integrated and the sensor feedback returns to a steady-state baseline. The algorithm looks for a correlated shift: a decrease in the hydraulic pressure signal P and a corresponding frequency shift in the acoustic signal A, where the sound shifts from low-frequency thuds to higher-frequency splashing sounds as the mix becomes more flowable, or visual changes. If the target material properties are not met, the process is repeated in a staircase manner. This ensures that the minimum amount of admixtures is used to achieve the maximum technical effect, avoiding the risk of flash setting or over-retardation.

Reference is now made to FIG. 3, which is a diagnostic graph illustrating the auxiliary electronic signal (P) from a pressure sensor as a function of time during the initial mixing and absorption phases. The graph depicts the transition from the volatile absorption phase to the stabilization plateau. During the initial wetting of dry raw materials, the mechanical resistance increases rapidly as the batch water is sequestered by the aggregate pores. Therefore, the pressure signal P exhibits an initial period of high volatility and a steep upward gradient. During this phase, the processing unit (24) continuously normalizes the primary electronic signal comprising visual data from the camera (38) against the drum rotational speed to ensure that the visual kinetic markers and flow patterns are monitored in a speed-independent manner.

The processing unit (24) identifies the stabilization event by monitoring the rate of change (ΔP/Δt) of this hydraulic pressure in combination with the rate of change of the normalized visual characteristics. In FIG. 3, this is represented by the transition into the aforementioned triple-event plateau. Mathematically, the processing unit (24) verifies this equilibrium state when fluctuations in the pressure signal P fall within a predetermined variance threshold confirming that the mechanical energy required to rotate the mixing drum (12) has reached equilibrium. This plateau is cross-validated through real-time image processing of the normalized visual kinetic markers and flow patterns, ensuring that the physical surface dynamics of the concrete mix (11) have also reached a steady-state plateau.

Reference is made to FIG. 4, which illustrates an auxiliary electronic signal A (acoustic signature) sampled by the acoustic sensor (20). The graph in FIG. 4 demonstrates a correlated frequency shift that mirrors the hydraulic stabilization shown in FIG. 3. During the initial absorption phase, the acoustic signature is dominated by low-frequency thuds caused by the impact of dry, unlubricated aggregates. As the stabilization event is reached, the APC identifies a frequency shift toward higher-frequency splashing sounds. This frequency shift represents a transition in interstitial fluid viscosity and a reduction in inter-particle friction, marking the moment when the aggregates are fully coated in cement paste.

The processing unit (24) is configured to sample these electronic signals at a high frequency, typically between about 10 Hz and about 100 Hz. This sampling rate is sufficient to capture the transient shifts in both viscosity and sound volume during each single revolution of the drum (12). Thus, by correlating the hydraulic pressure plateau in FIG. 3 with the acoustic frequency shift in FIG. 4 and the normalized visual flow characteristics from the camera (38), the system is able to achieve a robust, multi-modal confirmation that the concrete has moved beyond the aggregate absorption phase and has entered a chemically receptive state. This empirical evidence ensures that the control interlock is only released when the concrete has moved beyond this dangerous absorption phase, thereby protecting the technical efficacy of the subsequently introduced chemical admixtures.

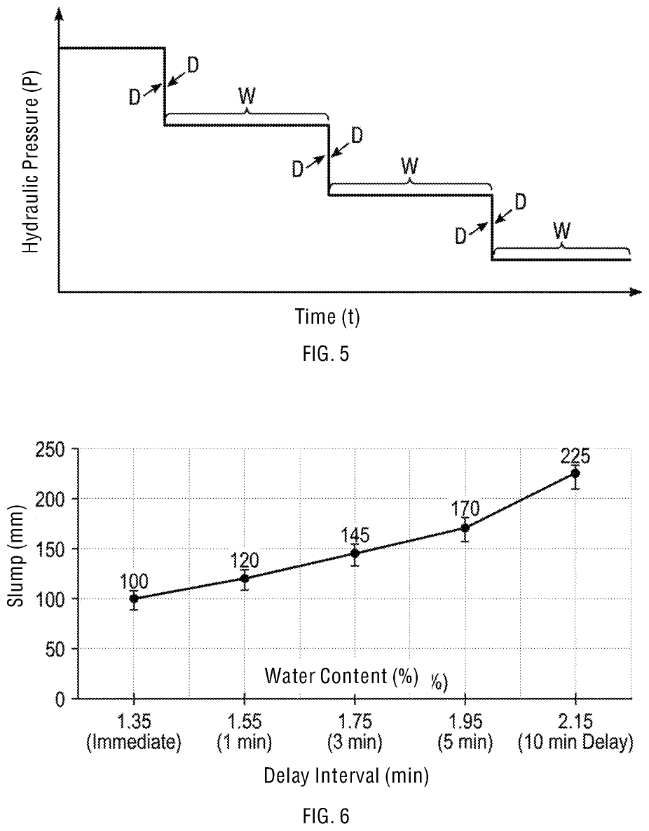

Reference is made to FIG. 5, which illustrates the staircase dosing protocol executed by the APC. Once the dynamic saturation index (DSI), calculated based on the multi-modal data and material variables such as aggregate quality, presence of contaminants and mix type, indicates the concrete mix has reached a chemically receptive state, the processing unit (24) initiates the active dosing phase and commands the admixtures delivery system (34) to introduce a first incremental dose (D). As illustrated in the graph of FIG. 5, the introduction of an incremental dose of a chemical admixture (D) results in an immediate and measurable drop in the hydraulic pressure. This P drop represents the reduction in shear stress and internal friction as the chemical molecules begin to adsorb onto the cement grains and provide lubrication within the matrix. The processing unit (24) generates the sequence of incremental doses (D) as a function of the mix type and a projected operational window until a final placement or discharge event, ensuring that the workability is maintained for the specific duration required by the application, such as 3D printing or high-strength structural pours.

Following this introduction of a certain dose, the system enforces a homogenization window (W), during which the drum (12) continues to rotate at a constant speed to ensure the chemical component is fully and uniformly distributed throughout the bulk mass of the concrete mix. This mechanical requirement is essential to allow the chemical kinetics to reach a state of equilibrium before any further intervention is attempted.

Unlike traditional systems that rely on a fixed revolution count as the sole metric for mixing, the present invention utilizes a Coefficient of Variation (CoV) protocol to determine the precise end of a homogenization window. The APC monitors the signal noise variance in the sensor feedback across the primary and auxiliary electronic signals and only permits a subsequent incremental dose when the noise returns to a steady-state baseline. In practice, this homogenization window comprises a duration of at least three revolutions of the rotating mixing drum (12) to ensure the processing unit (24) has sampled a statistically significant data set to confirm that the previous dose has fully integrated into the bulk mass. This ensures that each subsequent dose is inhibited until the processing unit (24) identifies a return to the steady-state baseline, indicating the completion of chemical dispersion.

During the homogenization window W, the processing unit (24) continues to sample the hydraulic and acoustic signals and the normalized visual flow characteristics to confirm that the rate of change (ΔP/Δt) has reached a new, stable plateau. This secondary stabilization check ensures that the system is reacting to a stable and integrated viscosity state rather than a transient fluctuation caused by the local concentration of the admixture near the sensor interface. Only when the derivative (ΔP/Δt) remains below the variance threshold for the duration of the window W does the APC evaluate whether the target material properties have been met.

This iterative staircase approach allows the system to walk the concrete fluidity up to the target in a controlled, multi-stage manner. By dividing the total required chemical volume into discrete incremental doses D, the system avoids the technical risk of overshooting the target. Such overshooting in traditional systems often leads to a state of segregation or bleeding, where the concrete matrix loses its structural cohesion. The protocol illustrated in FIG. 5 therefore acts as a tool for feedback stability, ensuring that the final product reaches its optimal workability plateau while preserving the structural integrity and uniformity of the mix. The APC dynamically adjusts the magnitude of each dose as a function of the deviation between the current steady-state baseline and the target material property, accounting for the specific concrete mix type requirements.

The method further provides for sequential chemical separation to maximize the efficacy of disparate admixture classes. As described in Step (VI) of the master control logic, the processing unit (24) manages the introduction of various chemical admixtures from independent reservoirs (16a, 16b). The system calculates a designated chemical-separation interval between the introduction of a first agent, for example a water reducer, and a second agent, for example a retarder. This sequence is calculated as a function of the mix type and a projected operational window until a final placement or discharge event. This delay ensures that the first species has successfully adsorbed onto the cement grains before the second species is introduced, preventing competitive adsorption. This kinetic gating allows for the use of admixtures with a lower solids content of less than 40%, which enhances dispersal efficiency within the limited homogenization windows.

During the execution of the staged dosing protocol in Step (VI), the sensory reliability weighting protocol dynamically adjusts the priority of the multi-modal feedback. As the environmental noise dissipates, including, without limitation, as dust within the rotating mixing drum (12) settles, and the mixture enters the chemical receptivity state, the processing unit (24) increases the reliability weight of the acoustic sensor (20) and the camera (38). This shift allows the APC to perform high-resolution monitoring of the microworld, where visual flow characteristics and acoustic frequency shifts provide more precise indicators of molecular lubrication and homogenization than bulk hydraulic pressure alone. By dynamically re-weighting these inputs and continuing to normalize the primary and auxiliary signals against drum speed and concrete volume, the APC maintains an accurate perception of the material state across the entire production cycle.

An optional, last step of the method provides for the adaptation to clay contaminants. In instances where the aggregates contain clay contaminants, the APC identifies a specific thermal inversion signature as shown in FIG. 21B. This signature represents a critical diagnostic tool in concrete quality control for identifying high-absorption or contaminated aggregates. While standard concrete mixtures are typically characterized by an exothermic hydration rise, materials with high absorption or clay content demonstrate a distinct thermal configuration characterized by a rapid temperature drop or a muted acoustic signature despite high mechanical resistance. In these instances, the physical process of water being rapidly drawn into the aggregate pores creates a detectable temperature drop or a negative rate of temperature change (ΔT/Δt) instead of the expected sharp rise and subsequent stabilization.

The APC identifies this negative thermal gradient as a specific diagnostic fingerprint of high-absorption materials by detecting a negative rate of temperature change (ΔT/Δt) instead of the expected exothermic hydration rise. In response to this identification, the processing unit automatically triggers a specialized kinetic management protocol where the dynamic saturation index (DSI) is adjusted based on the presence of contaminants and aggregate quality, utilizing a multi-modal verification involving acoustic, temperature, and hydraulic pressure signatures.

This extension, which is actually an autonomous switch to a specialized dosing protocol designed to counteract the internal moisture loss, allows more time for the clay contaminants to hydrate before the water-reducing agents are introduced. By proactively navigating these raw material variables, the APC prevents the catastrophic workability decay and slump retention that would otherwise occur as the aggregates sequester the liquid components of the mix. This is an example of how the APC protects the target material properties of the final product from the deleterious effects of premature chemical sequestration.

To summarize, the core of the kinetic management protocol is the mathematical evaluation of the rate of change (ΔP/Δt) of the hydraulic pressure normalized signal and the normalized primary electronic signal. In the context of concrete rheology, hydraulic pressure is a proxy for the shear stress required to move the mix. However, the absolute value of pressure can be influenced by batch volume or drum tilt. Therefore, the present invention relies on the first derivative of the pressure signal (ΔP/Δt) and visual kinetic markers to identify the internal energy state of the hydration process and absorption energy of the concrete mix.

The system of the present invention distinguishes between a pre-stabilization phase, where the derivative ΔP/Δt is high, and a stabilization plateau, where the derivative approaches near-zero. During the pre-stabilization phase, the dry raw materials are initially wetted, and the torque required to rotate the mixing drum (12) increases rapidly. This occurs because the batch water is being stolen or sequestered by the internal pores of the dry aggregates, by clay contaminants, and by the initial hydration reactions involving aluminate and ferrite components such as tricalcium aluminate (C₃A) and tetracalcium aluminoferrite (C₄AF). This physical phenomenon causes a continuous increase in internal friction and creates a steep upward slope in the hydraulic pressure curve. If chemical admixtures are introduced during this high-volatility phase, the admixture molecules follow the water into the aggregate pores and become permanently sequestered. This phenomenon is the initial absorption effect. Once sequestered within the pores, these admixture molecules are unable to interact with the cement grains, leading to a permanent loss of chemical efficacy and a failure to reach the target material properties.

The second state is the stabilization plateau characterized by near-zero rate of change. As the concrete mix reaches the triple-event plateau, the batch water becomes evenly distributed throughout the cement paste and the mechanical resistance becomes constant. This stabilization event, which occurs in Step (III) of the presently claimed method, is mathematically identified when the derivative ΔP/Δt flattens and stays below a predetermined variance threshold. This plateau provides empirical proof that the physical wetting process is complete, a fact cross-validated through real-time image processing of normalized visual kinetic markers and flow patterns. Any subsequent drop in hydraulic pressure observed after this point is not the result of physical wetting, but rather the result of chemical lubrication and adsorption on the cement grains.

By specifying that the derivative (ΔP/Δt) must stay below a predetermined variance threshold, the processing unit (24) distinguishes between temporary fluctuations and true rheological stability. This kinetic gating mechanism ensures that digital timer in Step (IV) is triggered and chemical energy is applied only when the physical energy of the mix has reached equilibrium, i.e. the concrete is chemically receptive. In other words, the system ensures that the subsequently added admixtures act primarily on the cement paste to maximize effectiveness while minimizing the total required chemical volume.

The system further implements a sensory reliability weighting protocol to navigate the complex environmental variables of a concrete mixer. The processing unit (24) is configured to assign a higher priority or reliability weight to the auxiliary hydraulic pressure transducer (26) during the initial loading phase when environmental noise often renders visual data from the camera (38) unreliable. As the mix stabilizes and environmental conditions within the drum clear, the system dynamically increases the weighting of the visual and acoustic signatures. This multi-modal transition allows the APC to maintain high-fidelity monitoring across the entire production cycle, from raw material introduction to final discharge. The normalization of the primary visual signal ensures that visual proxies such as flow angle, vortex depth, material cohesiveness, clumps, and bleeding can be monitored accurately as the reliability weight of the primary signal increases.

In one embodiment, the autonomous cyber-physical production system is configured to utilize its sensory array to identify a specific kinetic window for admixture introduction by monitoring the transition of aggregate moisture and absorption. The APC proactively navigates the initial aggregate absorption phase by identifying the precise moment the mix reaches a chemical receptivity state, thereby ensuring that the resulting workability is maximised for a given water and cement content.

Reference is now made to FIG. 6, which is an empirical bar graph illustrating the technical relationship between the timed delay interval, the cumulative water content, and the resulting workability (slump) of the concrete mix. This graph serves as the experimental justification for the control interlock executed by the APC and the preferred 10-minute delay duration that represents the conclusion of the absorption phase. The x-axis represents the delay interval from the initial batching and the corresponding water content detected by the sensory array, while the y-axis represents the achieved slump measured in millimeters (mm). The specific delay interval is adjusted as a dynamic saturation index (DSI) based on the mix type and aggregate quality to ensure target properties are met for the projected operational window.

As shown in the first data point, an immediate addition representing zero minutes of delay with a water content of 1.35% results in a baseline slump of only 100 mm. In contrast, as the APC perceives the progression of the absorption phase and incrementally increases the delay interval via its proactive processing unit (24), the technical efficacy of the liquid components improves significantly. A delay of 1 minute, corresponding to the water content reading of 1.55%, increases the slump to 120 mm, while a 3-minute delay at the water content of 1.75% achieves 145 mm. This upward trend continues through the 5-minute interval at 1.95% water content, which yields a slump of 170 mm.

The peak technical performance is observed at the 10-minute delay where the water content reaches 2.15 percent and the mix reaches a maximum slump of 225 mm. This data provides conclusive empirical proof that the APC, by delaying the introduction of admixtures until the sensors identify the conclusion of the initial aggregate absorption phase, allows the concrete to reach a substantially higher workability state without requiring additional cement or chemical volume. The non-linear increase in slump from 100 mm to 225 mm demonstrates that the chemical molecules are no longer being sequestered within the internal pores of the aggregates, but are instead fully available to lubricate the cement paste, thereby validating the kinetic management protocol of the APC. The APC uses this peak performance data to establish a target material property that is maintained throughout the projected operational window until final placement.

In another embodiment, the autonomous cyber-physical production system utilizes its APC to execute a multi-modal moisture fingerprinting protocol, wherein visual data from the camera (38) is processed to identify surface moisture characteristics and correlated with acoustic and thermal signatures. This visual data is normalized against the rotational speed and concrete volume of the drum to ensure that visual kinetic markers are accurately interpreted regardless of mechanical variations. This allows the APC to establish a high-fidelity sensory map of raw material variability, enabling the precise adjustment of the kinetic management protocol before the stabilization event is reached.

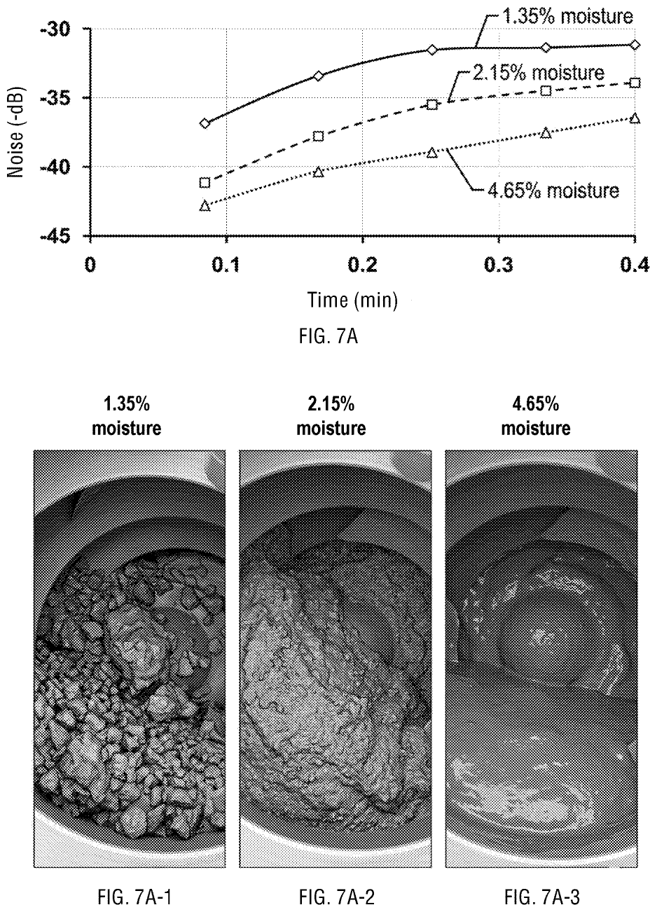

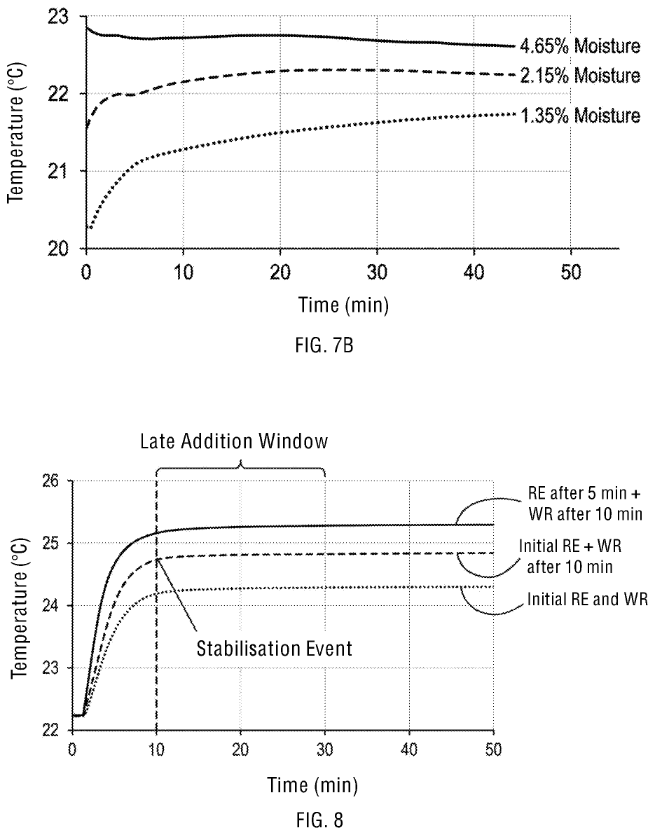

Reference is made to the experimental data illustrated in FIG. 7A and FIG. 7B, which together define the multi-modal moisture fingerprinting protocol of the present invention. They provide the sensory map for the kinetic management algorithm. These figures represent a series of controlled calibration experiments where concrete batches were prepared with varying moisture contents of 1.35%, 2.15%, and 4.65% to establish the sensory baselines required for the autonomous identification of raw material variability by the APC.

This multi-modal protocol represents a sophisticated diagnostic phase where the APC, embodied in the processing unit (24), autonomously evaluates the physical state of the raw materials through the fusion of sensor data and image processing before committing to a dosing strategy. This evaluation includes the identification of at least one material variable such as aggregate quality or the presence of contaminants which directly influences the calculation of the dynamic saturation index (DSI).

FIG. 7A depicts the acoustic response of the mixture during the initial loading and mixing phases. The experimental results demonstrate a clear and significant inverse correlation between the moisture content and the overall noise level, expressed in decibels (−dB). For the dry aggregate batch characterized by 1.35% moisture, the noise signature remains consistently high, oscillating near −31 dB. In contrast, the saturated batch with 4.65% moisture exhibits a significantly attenuated, muted acoustic signature, dropping to approximately −43 dB.

The technical reason for this significant decrease in noise, or acoustic dampening, as moisture content increases relates to the mechanical energy dissipation within the rotating mixing drum (12) and the formation of a boundary lubrication layer. In a dry or low-moisture state, the aggregates lack sufficient interstitial fluid, leading to high-energy mechanical impacts and frictional contact between the stones and the internal surfaces of the drum (12) or the mixing fins (14). This results in the generation of high-amplitude, high-frequency acoustic waves.

As the moisture content increases, the APC identifies the formation of a thin, viscous film of water that forms a boundary lubrication layer around each aggregate particle. This liquid layer acts as a mechanical dampener, converting kinetic energy into viscous thermal dissipation rather than sound. Consequently, the acoustic sensor (20) captures a muted signature that the processing unit (24) identifies as a high-moisture fingerprint. The APC is trained to recognize these specific decibel plateaus as acoustic fingerprints of the internal moisture state.

The visual dimension of this fingerprint is illustrated in FIG. 7A-1, FIG. 7A-2, and FIG. 7A-3, which are photographic images captured by the camera (38) representing the concrete mix obtained from dry, semi-dry, and wet aggregates, respectively. The APC utilizes image processing to analyze normalized visual kinetic markers and flow patterns, such as the texture of the mix and the distribution of water on the aggregate surfaces, to cross-validate the acoustic and thermal data.

FIG. 7B illustrates the corresponding thermal profiles for the same moisture variations, providing the second dimension of the moisture fingerprint. The figure demonstrates a clear divergence in temperature profiles based on aggregate moisture. The experiment reveals a specific thermal relationship where the moisture content dictates the rate of temperature change during the initial mixing minutes. The dry batch begins at a lower initial temperature of approximately 20.2° C. but exhibits a rapid upward gradient due to higher frictional energy.

Conversely, the high-moisture batch starts and remains at a higher, more stable temperature plateau of approximately 23° C. This thermal stability is a function of the increased specific heat capacity provided by the higher water volume, which acts as a thermal ballast, combined with the reduction in frictional energy generation. The APC identifies this stability as proof of low internal friction.

The processing unit (24) utilized the combined data from FIG. 7A, the image processing of FIG. 7A-1 through 7A-3, and FIG. 7B in order to distinguish between a dry load and a pre-saturated load. By identifying the correlation between the acoustic dampening, the normalized visual flow patterns, and the thermal stability profile, the APC is programmed to autonomously calculate the moisture content and identify presence of contaminants. Thus, the APC can detect the moisture state of the aggregates before the stabilization event is even reached.

This allows the APC to adapt the subsequent dosing volume and timing, ensuring that the chemical admixtures are not diluted or rendered ineffective by unexpected water content within the aggregate pores. For example, if the moisture fingerprint indicates dry aggregates, the processing unit (24) maintains the standard 10-minute delay interval. However, if a saturated fingerprint is detected, the system may autonomously reduce the delay interval to ensure the final workability plateau is achieved with maximum chemical efficiency.

From a legal standpoint, this supports the control interlock logic. If the sensors detect the rising temperature and high noise signature characteristic of the dry batch curve, the algorithm identifies that the mix is still in the initial aggregate absorption phase. During this phase, any introduced admixtures would be sequestered rather than staying in the cement paste. Therefore, the system must inhibit delivery until the stabilization event occurs, which is when these curves flatten out.

Within the context of an AI-driven implementation, the processing unit (24) interprets these acoustic, visual, and thermal plateaus as a multi-dimensional vector. The AI algorithm compares the real-time steady-state values against a pre-calibrated reference dataset to determine the moisture percentage with high precision without manual probes. Upon such autonomous detection, the APC of the autonomous cyber-physical production system, which is embodied in the processing unit (24), is programmed to adjust the kinetic management protocol dynamically.

For example, if a ‘dry fingerprint’ characterized by high noise and a rising temperature is identified, the APC enforces a 10-minute delay interval in Step (II) to account for the high absorption potential of the aggregates. Conversely, if a high-moisture fingerprint consisting of muted noise and a stable temperature is detected (verified through the multi-modal fusion of sensory signals and image processing), the APC may autonomously reduce the delay interval or decrease the volume of the first incremental dose in the staircase protocol. This adaptive logic ensures that the dosing operation is optimized for the specific moisture state and aggregate quality of each batch, preventing the risk of over-fluidization or chemical sequestration and thereby ensuring consistent quality for a projected operational window until final placement.

In still another embodiment, the autonomous cyber-physical production system is configured to execute a sequential chemical separation protocol through its APC, separating the introduction of water-reducing agents and retarding agents by a calculated chemical-separation interval. This proactive management prevents competitive adsorption on the cement grains, as verified by the identification of a specific thermal profile and the reduction of mechanical resistance in the mixer.

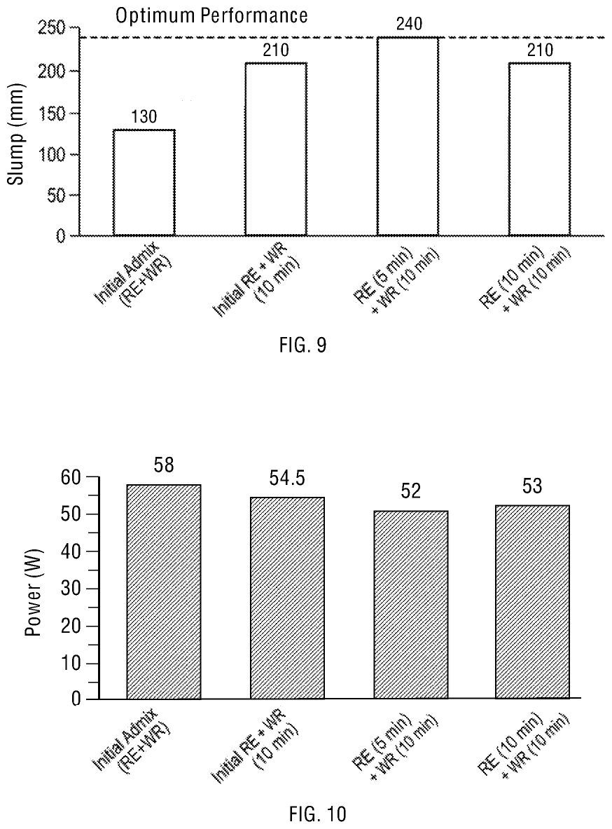

Reference is now made to FIG. 8, FIG. 9, and FIG. 10, which together provide the experimental proof for the technical superiority of the sequential chemical separation protocol defined in Step (IV). These experiments were conducted to quantify the rheological and thermal benefits of separating the introduction of the first agent from reservoir (16a) and the second agent from reservoir (16b).

FIG. 8 is a thermal profile graph illustrating the temperature of the concrete mix over a 50-minute duration. The experimental results demonstrate three distinct thermal pathways based on the timing of admixture introduction. The dotted line representing the traditional initial loading protocol, where both chemical agents are introduced simultaneously at the batching plant, exhibits the lowest thermal profile, plateauing at approximately 24.3° C. Conversely, the curves representing the staged loading of the invention, where a chemical-separation interval is enforced by the APC, demonstrate a significantly more robust thermal profile, reaching a peak of approximately 25.3° C.

The technical justification for the higher temperature observed in the staged addition relates to the facilitation of the hydration reaction, avoiding the high-energy, inefficient chemical reaction that occurs when disparate molecules compete for the same active sites on the cement grains. When the retarder (RE) and water reducer (WR) are added initially, they over-suppress the early hydration energy, leading to the lower thermal plateau.

By delaying the introduction of the retarder (Step V of the method) until the water reducer has successfully adsorbed onto the cement surfaces, the APC avoids the chaotic energy release associated with competitive molecular interference and allows the initial hydration energy to build unhindered during the late addition window. This identification of hydration state is cross-referenced with normalized visual data to ensure that the chemical receptivity state has been achieved.

This ensures that the chemical energy is applied to a chemically receptive mix that has already passed through the stabilization event. As used herein, identifying the stabilization event includes identifying a kinetic stabilization of initial hydration reactions involving the aluminate components, specifically tricalcium aluminate (C₃A) and tetracalcium aluminoferrite (C₄AF), and the silicate components of the cement. The controlled thermal profile serves as a proxy for optimized hydration kinetics, indicating that the admixture molecules are anchoring to the cement grains effectively within the cement matrix, rather than suppressing the mix prematurely in the interstitial fluid.

FIG. 9 illustrates the corresponding workability results, plotting the slump for the same experimental protocols. The data indicates that the initial simultaneous loading results in a significantly lower slump of only 130 mm. In contrast, the staged loading protocol achieves an optimum performance slump of 240 mm. This provides conclusive empirical proof that sequential separation not only facilitates a more robust hydration profile but also maximises the fluidization efficiency of the water reducer molecules.

Reference is now made to FIG. 10, which validates these findings by measuring the required mixer power. The data in this experiment proves that the kinetic management protocol does not only improve the slump but also significantly reduces the power required to mix the concrete. Specifically, the power consumption drops from 58 W to 52 W at 20 rpm when the addition is optimized by the APC. The initial admix requires a power of 58 W to rotate the drum. However, the optimum staged protocol of “RE (5 min)+WR (10 min)” reduces the required power to its lowest level of 52 W. This 6 W reduction is the rheological fingerprint of the improved chemical lubrication achieved through sequential separation. The similar result is also achieved at 4 rpm with the power drop from 132 W to 121 W for the optimized protocol. This reduction in mechanical wear and energy costs represents a powerful secondary technical effect.

The processing unit (24) utilizes the correlation between the higher thermal facilitation in FIG. 8, the peak slump in FIG. 9, and the reduced power in FIG. 10 to verify that the mix has reached the stabilized workability plateau. This verification is further supported by the extraction of visual proxies from normalized visual data to monitor material cohesiveness and the absence of clumps. By enforcing these sequential interlocks, the APC ensures that the chemical agents act with maximum technical effect, avoiding the competitive adsorption that leads to the workability decay seen in traditional production methods. This multi-modal verification ensures that the final concrete product meets all technical specifications while utilizing the minimum required volume of chemical admixtures.

In a further embodiment, the autonomous cyber-physical production system utilizes its APC to perform a real-time geometric analysis of the concrete mix (11) within the mixing drum (12) and differentiate between a stable workability plateau and a segregated state through real-time image processing of the flow geometry. The APC is configured to extract a flow angle, a vortex depth, a material cohesiveness, a presence of clumps, and a bleeding state from normalized visual data provided by the camera (38) as a visual proxy for viscosity, yield stress, and homogenization.

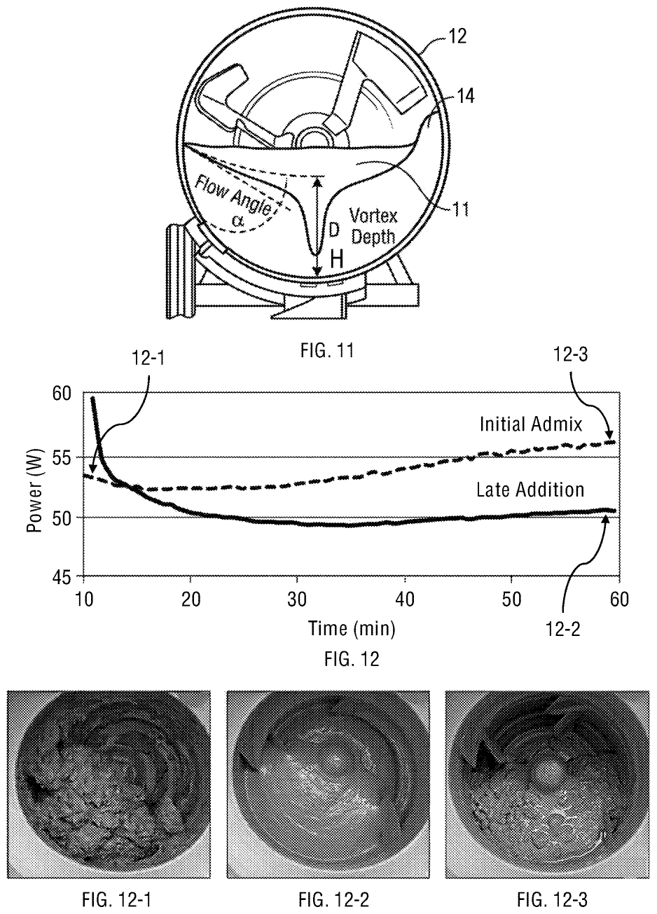

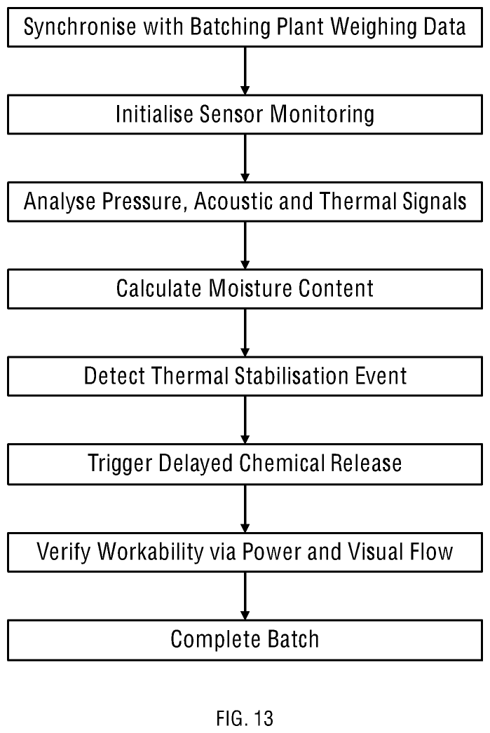

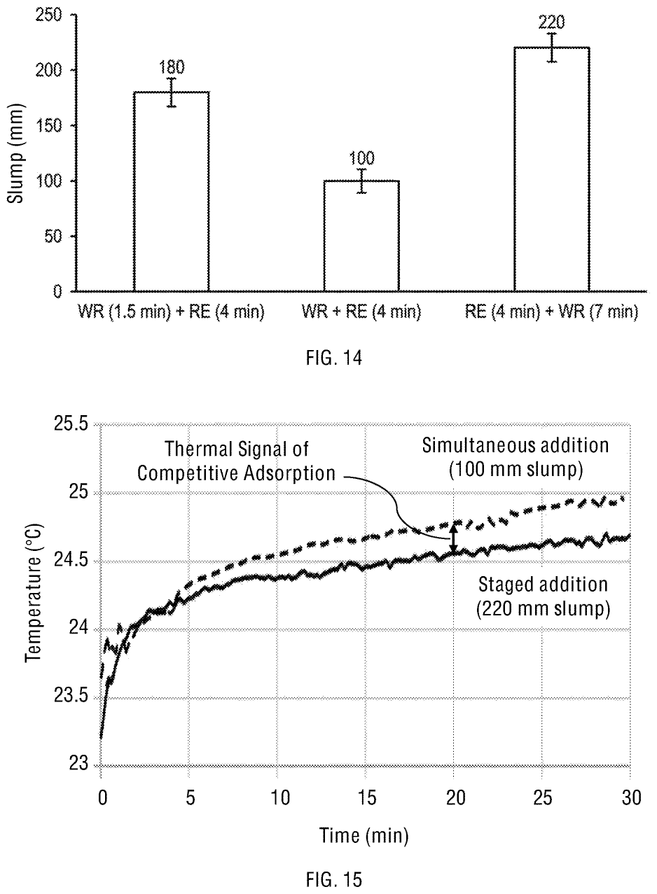

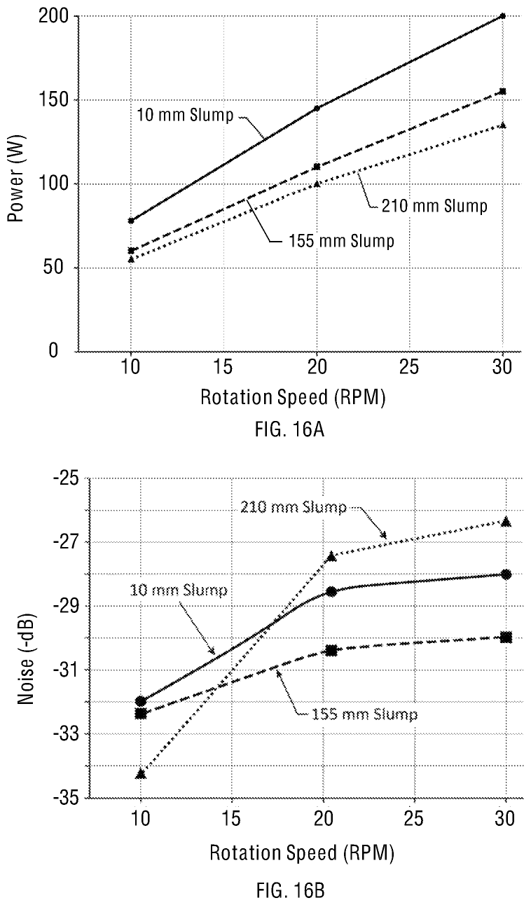

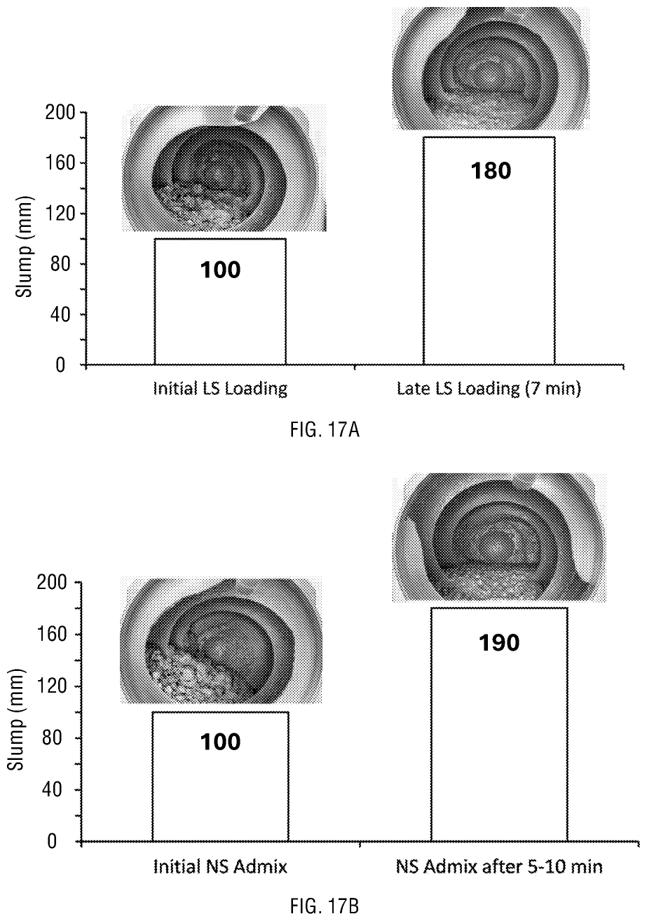

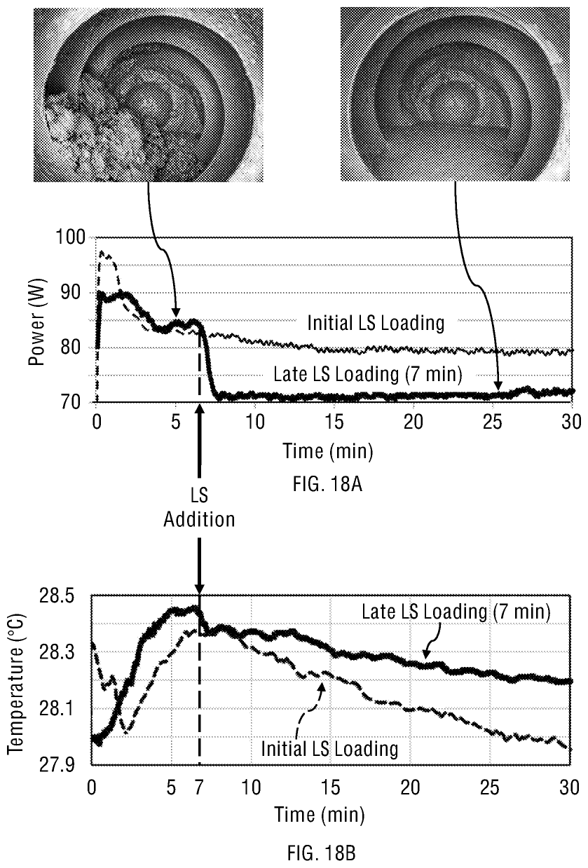

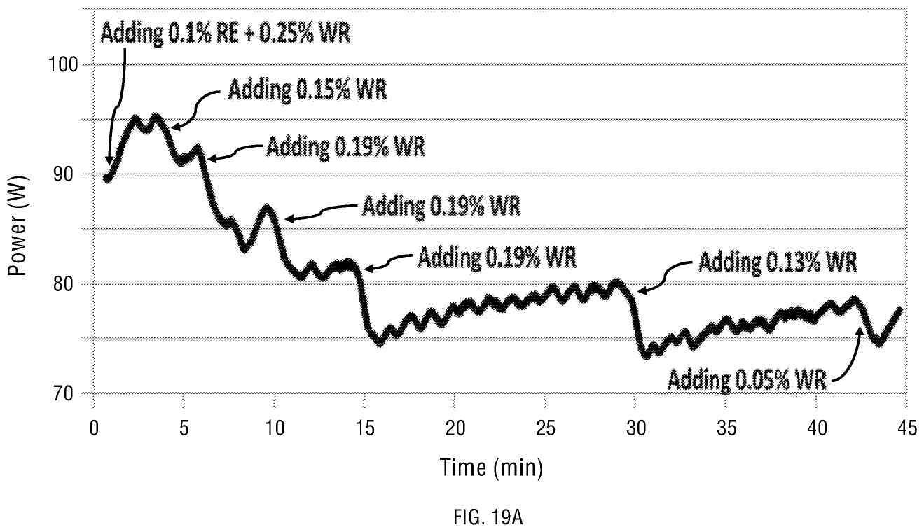

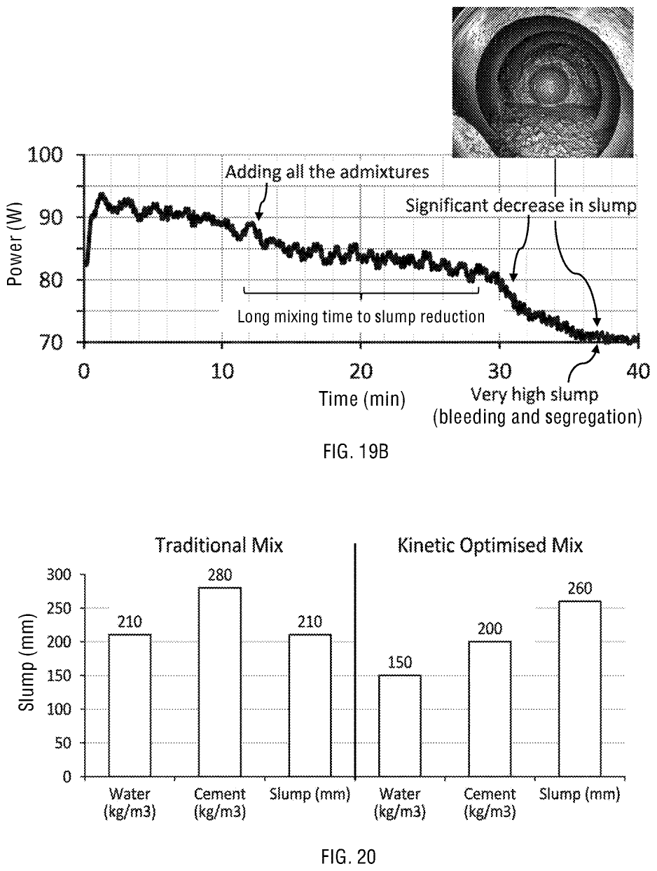

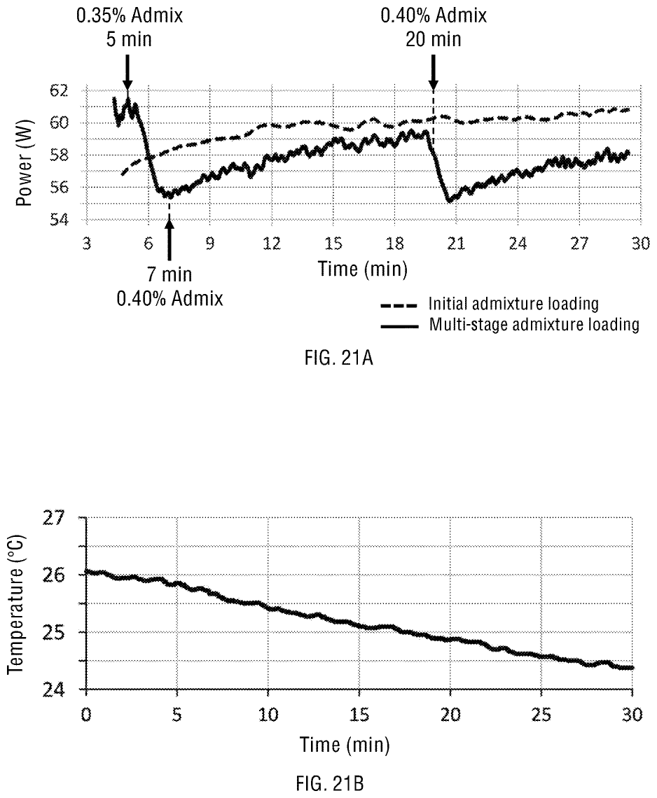

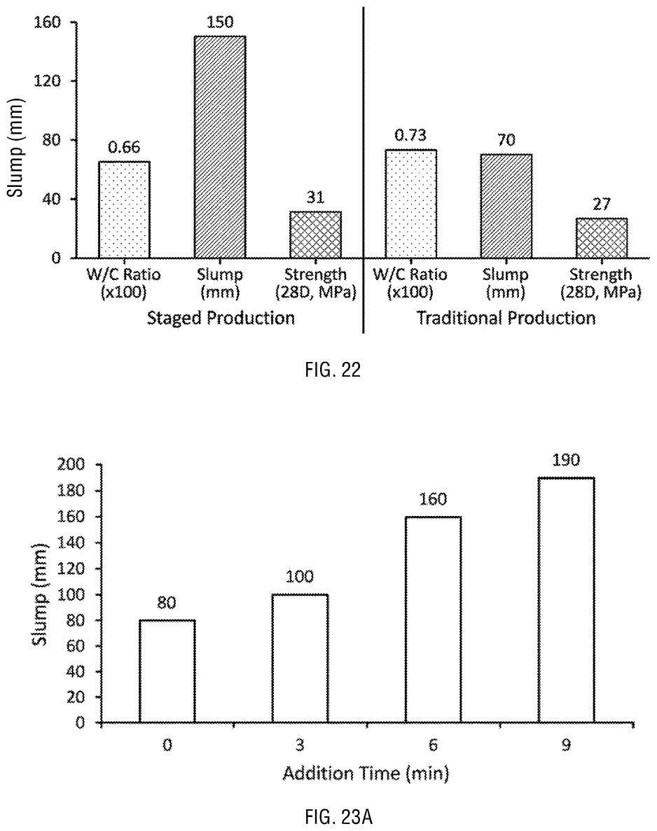

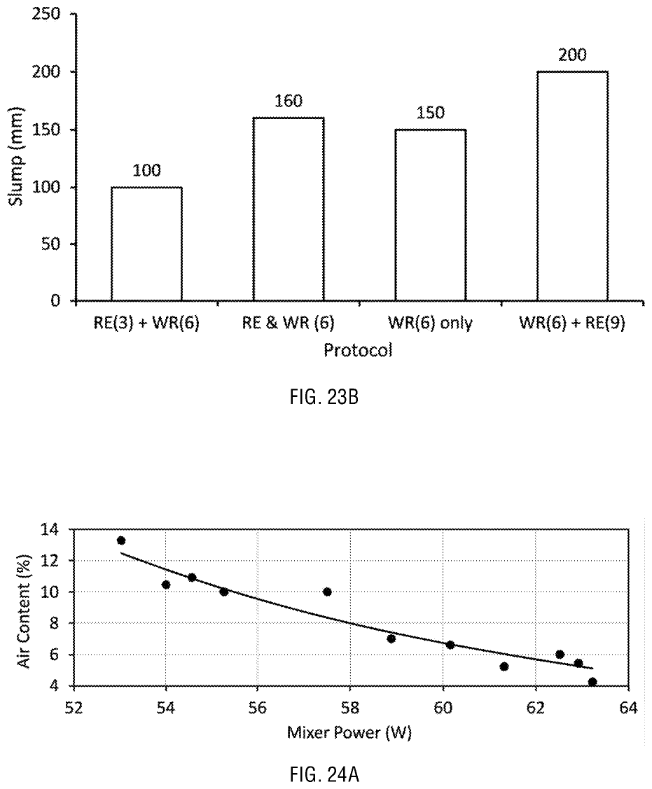

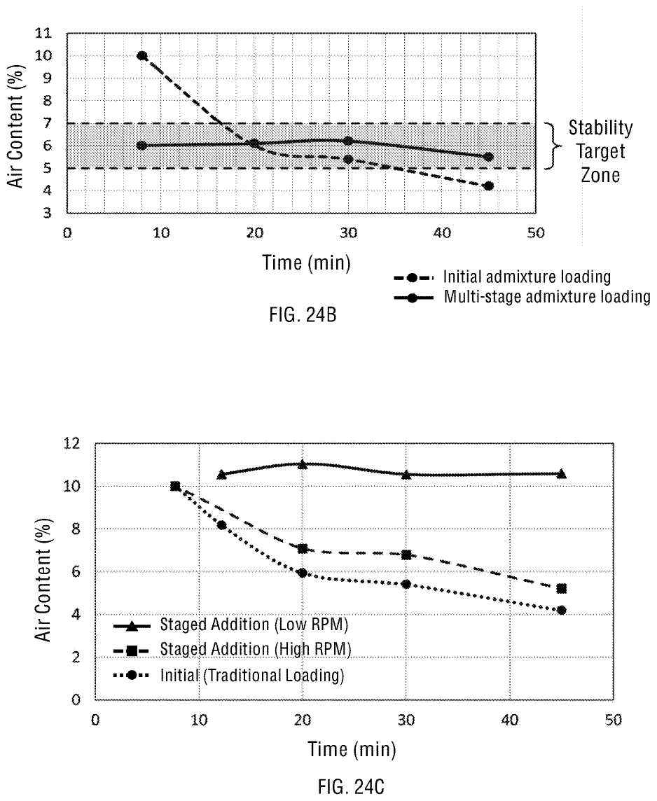

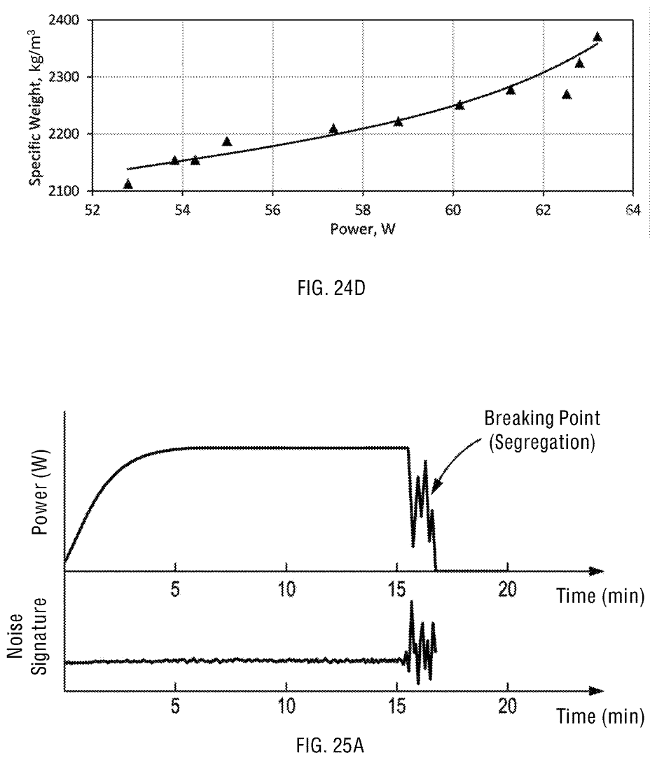

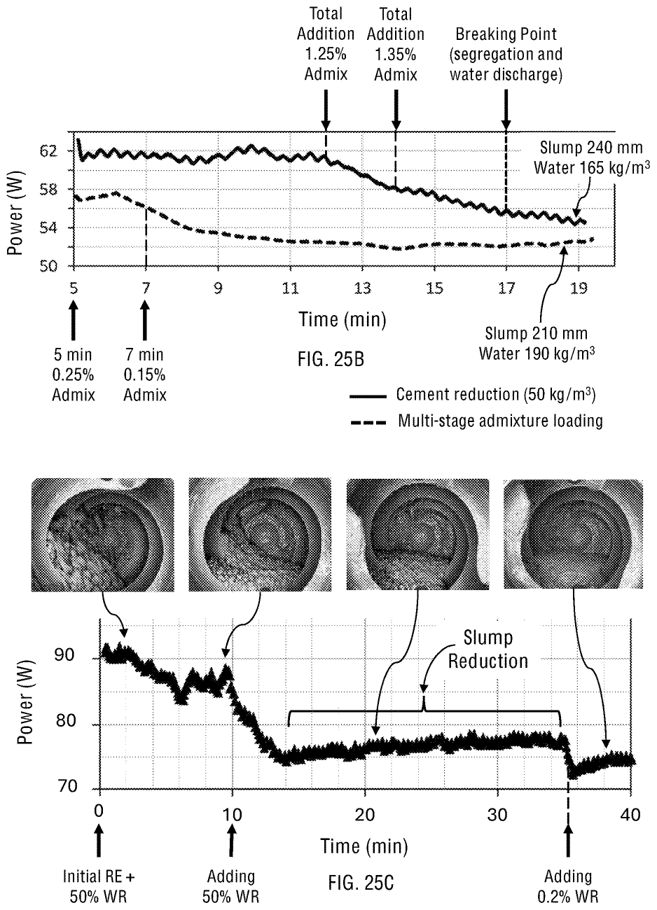

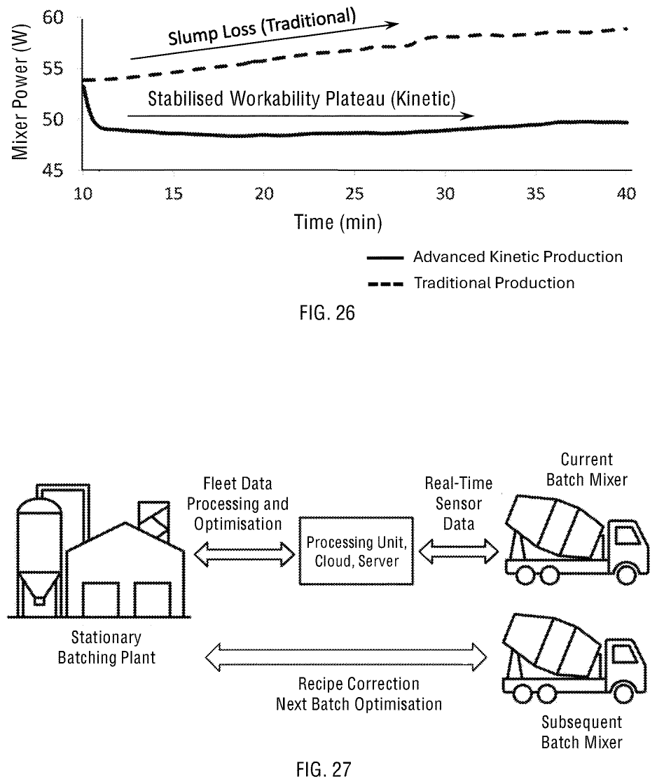

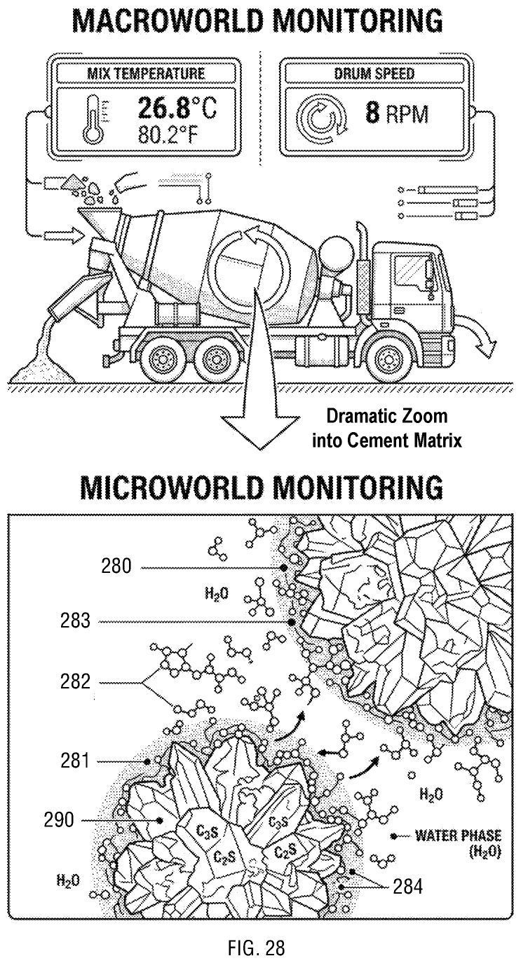

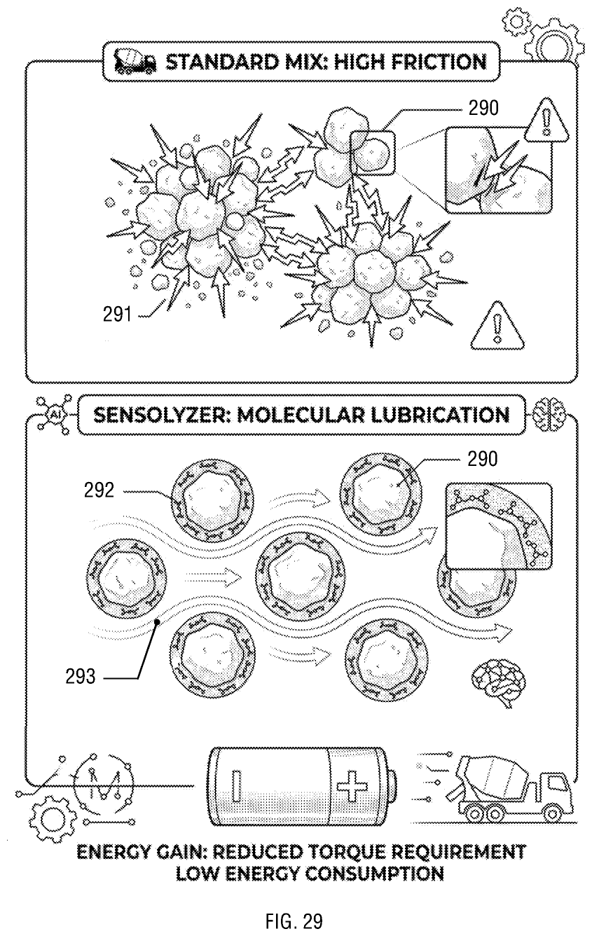

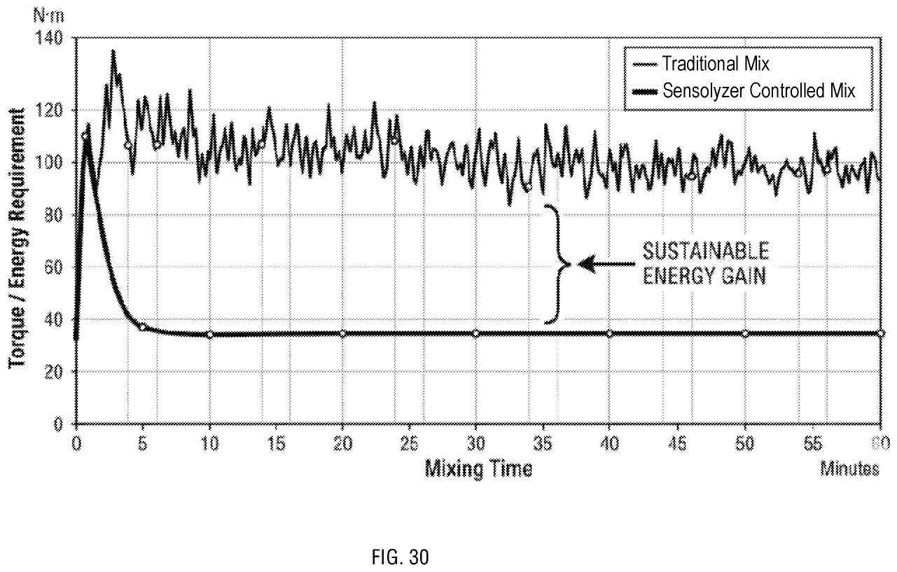

Reference is made to FIG. 11, which illustrates a cross-sectional view of the rotating mixing drum (12), providing a visual representation of the internal fluid dynamics and the physical parameters utilized for the verification of the concrete's workability state. The geometry of the concrete mix (11) within the drum (12) is characterized by specific rheological indicators that the APC identifies to complement the electronic sensor data.

As shown in FIG. 11, the internal movement of the concrete mix (11) creates a distinct flow profile defined by the flow angle α and the vortex depth H. The flow angle α represents the angular position of the material as it is carried upward by the spiral mixing fins (14) before cascading back toward the centre of the drum (12). The APC identifies that a steeper flow angle α is indicative of a higher internal yield stress and lower workability, as the material resists gravitational descent until reaching a higher angular elevation within the rotating drum (12).

Simultaneously, the APC monitors the vortex depth H, which is the vertical distance between the peak of the cascading mix (11) and the lowest point of the central depression or vortex formed by the centrifugal and gravitational forces acting on the mix. The H value serves as a direct visual proxy for the viscosity of the concrete matrix. Prior to the full execution of the fluidization protocol, a stiff mix (11) adheres to the drum (12) and the spiral mixing fins (14) for a longer duration of the rotation, reaching a higher angular elevation before cascading. The APC normalizes these geometric measurements against drum speed to ensure that changes in H and a reflect material rheology rather than mechanical speed shifts.

To account for this, the APC instructs the admixture delivery system (34) to introduce admixtures through the incremental staircase dosing protocol to increase flowability. As a result, the internal resistance of the mix (11) is reduced, causing the material to become more flowable and cascade at a lower angular position. Consequently, workability increases, the flow angle α becomes shallower (decreases) and the vortex depth H increases, reflecting a more fluid and integrated mechanical state that is captured in real time by the camera (38).

The APC embodied in the processing unit (24) correlates these visual parameters with the real-time feedback from the hydraulic pressure transducer (26) and the acoustic sensor (20) to establish a high-confidence assessment of the batch homogeneity. Furthermore, identifying a stabilization event in Step (III) involves cross-validating the plateau through real-time image processing of normalized visual kinetic markers and flow patterns, including the identified flow angle α and vortex depth H.

With reference to the logic in FIG. 2, this multi-modal approach actually ensures that the “Target Workability Met?” decision node illustrated in the flowchart of the invention is supported by both mathematical derivatives and physical flow characteristics.

By identifying the specific equilibrium between these two values, specifically the flow angle α and the vortex depth H, the APC distinguishes between a temporary mechanical dip and true rheological stability. This ensures that the homogenization window W is successfully concluded only when the physical geometry of the mix confirms that the chemical energy from the admixtures has been fully distributed and the mix has reached its optimal fluidization state for the projected operational window until discharge.

In yet further embodiment, the system identifies a breaking point by detecting the sustained high-power signature in conjunction with the visual data normalized against the rotational speed and concrete volume indicating a collapse of the mix structure, such as segregation or water bleeding, and immediately triggers a safety interlock to inhibit delivery.

Reference is now made to FIG. 12, which illustrates the dynamic optimization of the mixing process through real-time power monitoring, and to FIGS. 12-1, 12-2 and 12-3, which provide the corresponding visual validation for the mechanical data cross-referenced with normalized visual kinetic markers. The experimental results confirm that the APC is capable of identifying the exact mechanical and visual moment of workability change.

As evidenced by the power signature in FIG. 12, the traditional initial admix protocol requires a high and sustained mixer power of approximately 58 W. This mechanical resistance is visually explained by FIG. 12-1, which depicts the initial state of the initial admix protocol where the chemical agents are added prematurely. The APC identifies a high flow angle and a shallow, poorly defined vortex in FIG. 12-1, representing a mix with high internal yield stress that has not yet achieved effective fluidization. The APC utilizes image processing to analyze normalized visual kinetic markers and flow patterns, such as the material cohesiveness and the presence of clumps, to verify this high-friction state.

The failure mode of this traditional approach is further illustrated at the end of the initial admix curve in FIG. 12, where the power remains high or becomes erratic. This corresponds to the broken mix state shown in FIG. 12-3. In this state, the APC identifies a critical breaking point through image processing as the flow geometry collapses. The aggregate particles separate from the cement paste and water begins to bleed to the surface, indicating that the mix has suffered from segregation. By identifying this visual signature of failure including a bleeding state alongside the sustained high-power consumption, the APC can proactively intervene to prevent the delivery of a compromised batch.

In contrast, the late addition protocol managed by the APC exhibits a sharp and nearly instantaneous drop in power consumption at the conclusion of the stabilization interval. This drop, from approximately 58 W to 52 W, serves as empirical proof of the immediate change in the internal workability. The visual state corresponding to this optimized mechanical point is shown in FIG. 12-2, where a deeper vortex and shallower flow angle confirm the internal resistance has been minimized through the correct kinetic management of the admixtures.

The APC utilizes this power drop as a mechanical handshake to confirm that the target material properties have been met. By identifying the specific equilibrium where the power signature of 52 W correlates with the visual indicators in FIG. 12-2, the APC ensures that the chemical energy from the admixtures has been fully and effectively distributed. This multi-modal verification ensures that the final concrete product meets all technical specifications while utilizing the minimum required volume of chemical admixtures, thereby avoiding the competitive adsorption and workability decay seen in traditional production methods. The APC maintains this workability plateau for the duration of the projected operational window until a final placement or discharge event.

In some embodiments, the autonomous cyber-physical production system executes a centralized automated logic via the APC to manage the batch cycle through a closed-loop reactive architecture. The APC is configured to calculate aggregate moisture and identify thermal stabilization events to trigger delayed chemical release only after physical equilibrium is confirmed. The APC dynamically adjusts the delay interval as a dynamic saturation index (DSI) based on at least one material variable selected from a group consisting of an aggregate quality, a mix type, and a presence of contaminants. In other embodiments, the APC performs a real-time verification of the workability state by integrating visual flow parameters normalized against the rotational speed and concrete volume into its computational decision-making flowchart to ensure batch consistency regardless of raw material variability.

Reference is now made to FIG. 13, which illustrates the centralized automated logic executed by the APC to manage the batch cycle. The processing unit identifies the specific thermal stabilization event that signifies the conclusion of the triple-event plateau. Once this physical equilibrium is confirmed, the APC triggers the delayed chemical release. The flowchart establishes the closed-loop proactive architecture required to ensure that every batch reaches its optimal workability plateau regardless of raw material variability.

While FIG. 11 provides the physical definitions for visual parameters such as vortex depth and flow angle, FIG. 13 represents the logic flowchart of the computational steps executed by the processing unit (24). For the purpose of an AI-implemented disclosure, FIG. 13 provides a functional zoom-in on the algorithm, bridging the gap between raw image capture and the resulting control actions. Furthermore, while FIG. 1C and FIG. 1D define the hardware apparatus and FIG. 2 outlines the high-level method, FIG. 13 details the functional logic of the software. It explains precisely how the APC interprets multimodal sensor data, including image processing flows, to make the discrete decision to trigger the chemical release. This granular algorithmic disclosure ensures that the ability of the APC to navigate subtle sensory signatures is fully enabled for implementation.

In a certain embodiment, the APC is configured to mitigate competitive adsorption within the cement matrix by enforcing a sequential separation protocol between disparate chemical admixtures. The APC is programmed to identify a thermal signal of competitive adsorption, defined by a specific caloric deviation, and adjusts the timing of the second agent introduction to ensure optimal lubrication. The sequence of introduction is calculated as a function of the mix type and a projected operational window until a final placement or discharge event. In a particular embodiment, the system utilizes a 0.3° C. thermal deviation as an early warning proxy to identify molecular interference, allowing the APC to ensure that chemical molecules anchor correctly within the cement matrix rather than reacting prematurely in the interstitial fluid.

Reference is now made to FIG. 14 and FIG. 15, which provide the technical foundation for the invention embodiments regarding competitive adsorption within the cement matrix. This phenomenon occurs when multiple chemical admixtures compete for the same available surface sites on the cement particles, leading to a huge reduction in overall efficacy. The experimental data in FIG. 14 proves that simultaneous addition is the least efficient protocol. Specifically, the simultaneous addition of a water reducer and a retarder at the 4-minute mark results in the poorest performance, achieving a slump of only 100 mm. The first protocol, while better, achieves only 180 mm. The APC quantifies the total required volume for each chemical admixture by establishing a steady-state baseline for the normalized auxiliary electronic signals and correlating said baseline with the visual flow or slump characteristics from the primary electronic signal

The peak technical efficacy is achieved by the sequential separation protocol enforced by the APC, where the retarder is introduced at 4 minutes followed by the water reducer at 7 minutes, yielding a maximum slump of 220 mm. This surprising 120% improvement in workability is achieved not only by utilizing the APC to separate the additions, but through a minor adjustment in timing, which is critical unexpected result evidence proving the non-obviousness of the invention. This data confirms that the order of chemical introduction is critical. By allowing the retarder to anchor first, the subsequently added water reducer can achieve a more uniform and effective lubrication of the cement paste throughout the projected operational window.

Reference is now made to FIG. 15, which illustrates the thermal profiles associated with the sequential agent experiments described in relation to FIG. 14. The graph distinguishes between a simultaneous addition and the staged addition of chemical admixtures. As shown in the thermal signals, the simultaneous addition results in a higher temperature profile, rising to approximately 24.9° C. within 30 minutes. This uncharacteristic temperature rise is identified by the APC as the thermal signal of competitive adsorption. The APC cross-references this thermal signature with the acoustic signal to identify a kinetic stabilization of initial hydration reactions involving the aluminate and ferrite components, specifically tricalcium aluminate (C₃A) and tetracalcium aluminoferrite (C₄AF), as well as silicate components.

This thermal signal provides empirical proof that when disparate chemical molecules are introduced simultaneously, they compete for the same adsorption sites on the cement grains. This molecular competition generates excess caloric energy that does not contribute to the fluidization of the mix, leading to the significantly lower 100 mm slump observed in FIG. 14. This indicates a poorer inhibition of the hydration process, suggesting that the retarder is less effective at controlling hydration heat when distracted by the simultaneous presence of the water reducer. The APC uses this thermal deviation as an early warning proxy to isolate material kinetics from environmental variables by indexing it against sampled ambient temperature and humidity.

Conversely, the staged addition curve in FIG. 15, managed by the APC, maintains a lower and more efficient hydration profile, reaching approximately 24.6° C. This lower thermal gradient indicates that the chemical reactions are proceeding in a controlled, non-competitive manner, ensuring that the maximum chemical energy is converted into rheological workability rather than wasted heat. In fact, FIG. 15 acts as the primary comparative evidence to justify the staged addition protocol by providing the competitive adsorption proof.

This experimental note confirms that the 0.3° C. thermal deviation is the direct signature of poorer inhibition. By adding the chemicals simultaneously, their individual efficacy is reduced, which manifests as higher hydration heat and a significant loss in slump. The staged addition protocol, maintaining a more controlled profile of roughly 24.6° C., confirms that the molecules are anchoring correctly within the cement matrix rather than reacting prematurely in the interstitial fluid. Identifying the stabilization event in Step (III) involves detecting a thermal plateau following the exothermic hydration peak associated with the silicate and aluminate components.

In the context of the present invention, the experimentally observed 0.3° C. thermal deviation is utilized by the APC as a high-precision early warning signal or proxy for chemical interference. While a 0.3° C. difference may appear subtle, the ability of the APC to distinguish between a 24.6° C. profile and a 24.9° C. profile is the enabling mechanism that unlocks the disproportionate technical effect of achieving a 220 mm slump instead of a 100 mm slump. By framing this subtle thermal stabilization event as a decision-making trigger, the present invention teaches that high-precision hydration monitoring is the key to preventing competitive adsorption and achieving maximum workability with minimum chemical volume.

In a different embodiment, the APC performs a multi-modal workability verification by correlating mechanical resistance with acoustic dampening across a plurality of rotation speeds. The processing unit normalizes the visual data from the primary electronic signal and the acoustic auxiliary signal against the rotational speed to isolate material viscosity from mechanical speed shifts. The APC is configured to cross-reference mixer power data with a localized fluidity fingerprint obtained from acoustic signatures to ensure workability resilience regardless of mechanical variations. In a particular embodiment, the APC utilizes acoustic signatures to confirm mechanical resistance at elevated rotation speeds, where the separation between acoustic profiles is maximized, thereby providing a high-confidence assessment of internal workability that is superior to single-sensor configurations.

Reference is now made to FIG. 16A and FIG. 16B, which illustrate the multi-modal workability verification logic of the APC through a correlation of mechanical and acoustic signatures across varying operational speeds. FIG. 16A is a graph demonstrating that the primary hydraulic proxy for workability, measured as mixer power, maintains a robust and consistent correlation with concrete slump across a wide range of mechanical states, specifically at rotation speeds of 10, 20, and 30 RPM.

The experimental data includes three distinct curves corresponding to specific slump levels of 10 mm (stiff), 155 mm (medium), and 210 mm (fluid). As evidenced by the graph, higher workability consistently requires lower mixer power regardless of the mechanical state or rotation speed of the drum, proving that the control logic of the APC remains resilient against variations in mixer hardware and operating conditions, such as rotation speed. The APC utilizes this normalized power data to establish a steady-state baseline for the auxiliary electronic signals. FIG. 16B provides the acoustic dimension of the multi-modal verification logic. While mixer power serves as the primary macro-indicator of yield stress, the acoustic signature, which is a noise level measured in decibels, provides a localized fluidity fingerprint for cross-validation that correlates with the physical state of the mix. The data demonstrates that acoustic signatures distinguish between different slump states, with the most distinct separation emerging at higher rotation speeds between 20 and 30 RPM.

The processing unit normalizes the auxiliary acoustic signal and visual data against the rotational speed and concrete volume to isolate material viscosity from mechanical speed shifts. As clearly seen in the present experiment, at these elevated rotation speeds, the separation between the acoustic profiles for different slump levels is maximized. This supports the cross-validation logic executed by the APC and allows it to cross-reference the mechanical resistance data with the acoustic dampening data, where the APC uses acoustic data to confirm the mechanical resistance reported by the power sensors. The acoustic signal represents a transition in interstitial fluid viscosity that mirrors the stabilization of initial hydration reactions involving the aluminate and ferrite components, specifically tricalcium aluminate (C₃A) and tetracalcium aluminoferrite (C₄AF). This multi-modal approach ensures that the autonomous cyber-physical production system more accurately determines the internal workability of the mix than traditional single-sensor configurations, regardless of the specific mechanical characteristics or the current speed of the mixing drum (12).

In some embodiments, the APC is configured to demonstrate universal compatibility with a plurality of chemically distinct admixtures, including lignosulfonate and naphthalene sulfonate-based agents. The APC manages the kinetic absorption of these agents to achieve a superior workability state compared to traditional initial loading methods. In another embodiment, the APC utilises a multi-modal sensor fusion involving hydraulic, acoustic, visual, and thermal signatures to provide redundant and high-reliability verification of the mix state.

The APC quantifies a total required volume of chemical admixture by establishing a steady-state baseline for the normalized electronic signals and generates a sequence of incremental doses calculated as a function of the mix type and a projected operational window until a final placement or discharge event. This architecture ensures that even if a single sensory input is unavailable, the APC can continue to monitor the workability and thermal life of the retarder to ensure optimal production stability.

Reference is now made to FIG. 17A and FIG. 17B, which visually confirm the universal compatibility of the kinetic management protocol across different admixtures. FIG. 17A contrasts the performance of lignosulphonate (LS) based admixture, while FIG. 17B illustrates the results for naphthalene sulphonate (NS) admixtures. The bar charts and corresponding photographic images captured with the camera (38) clearly demonstrate the technical efficacy of the late addition window. The APC identifies the specific mix type and aggregate quality and adjusts the dynamic saturation index (DSI) to trigger the delayed chemical release based on the multi-modal data and material variables. As shown in the empirical results, a traditional initial loading of a 1.3% LS or NS concentration results in a poor workability state of only 100 mm slump. The visual snapshots for these initial loading states depict a stiff, clumpy mix that lacks cohesion.

However, by utilizing the late addition window as identified by the APC, the same chemical concentration achieves a superior workability of 180 mm slump for LS and 190 mm for NS. The corresponding photographic images for the late addition protocols visually validate this performance jump, showing a smooth, fluid, and integrated concrete matrix. This workability plateau is cross-validated through real-time image processing of normalized visual kinetic markers and flow patterns from the primary electronic signal. This evidence proves that the APC's ability to navigate the aggregate absorption phase is effective across specialized chemical families, extending the scope of the invention beyond generic water reducers.

FIG. 18A provides the visual proof of real-time optimization for these admixtures by plotting the mixer power as a function of time. The bold power curve illustrates the mechanical state of the mix and its transition as it passes through the addition event. Prior to the addition, the power consumption remains at a high plateau of approximately 90 W, reflecting the high internal friction and stiff mechanical state of the concrete. This state is visually represented by the left photo image inset, which shows the stiff mix adhering to the drum surfaces.

The APC normalizes the auxiliary power signal and visual flow characteristics against drum speed and concrete volume to establish a steady-state baseline. At the exact mark identified by the APC as the optimal window, the admixture is introduced and the graph exhibits a dramatic and nearly vertical step-down to a much lower power level of approximately 72 W. The right photo image inset visually confirms this transition, showing the immediate fluidization and improved flow texture of the mix.

Reference is made to FIG. 18B, which shows the thermal dimension of the experiments and defines the diagnostic logic used to identify retarder expiration. The graph compares the thermal profile of an initial loading (dashed curve) with a delayed loading (solid curve). In the initial loading scenario, the temperature signal initiates a rapid rise, indicating that the retarder has failed to inhibit hydration heat due to premature sequestration. The processing unit identifies a thermal plateau following the exothermic hydration peak associated with silicate and aluminate components to verify kinetic stabilization. Conversely, the delayed loading managed by the APC maintains a controlled thermal rise. This thermal signature is utilized by the APC as a retarder expiration diagnostic to track the inhibition of concrete bonding and the remaining life of the chemical agents in real time.

The APC correlates these thermal, acoustic, and mechanical signals to provide a redundant and highly reliable assessment. While the system is most effective when all sensors work in concert, the architecture allows for continued operation even if one sensor data stream is interrupted, as the APC can cross-reference the remaining signals to maintain production safety. If a premature temperature rise is detected, the processing unit (24) can trigger remedial actions, such as a secondary admixture release from the delivery system (34), to maintain the target workability window.

In summary, the multi-modal approach illustrated in these figures defines the resilient cross-validation mechanism of the invention. By correlating hydraulic pressure, measured as mixer power, with acoustic signatures, rotation speeds, and visual flow profiles, the APC accurately determines the target material properties regardless of the specific mechanical characteristics of the mixing drum. The primary electronic visual signal is normalized to extract visual proxies including flow angle, vortex depth, material cohesiveness, clumps, and bleeding. This integrated sensor fusion ensures that chemical energy is applied only when the physical state of the mix is receptive, maximizing workability while minimizing total chemical volume.

In other embodiments, the APC is configured to navigate the concrete mix toward a target state by executing an incremental dosing loop, where the magnitude of each dose is modulated based on the detected deviation from target material properties such as workability, air percentage, specific weight, or the onset of segregation.

In still another embodiment, the APC provides a safety interlock by identifying a mixture breaking point characterized by an unstable drop in mechanical resistance and a corresponding visual collapse of the flow geometry. This breaking point identification involves detecting a rapid downward spike or a drop in hydraulic pressure in the auxiliary electronic signal occurring simultaneously with a threshold increase in an acoustic signal and a visual detection of aggregate segregation

Reference is now made to FIG. 19A, which depicts the incremental dosing loop or staircase progression executed by the processing unit (24) in accordance with the method of the present invention. The graph illustrates the active rheological management of the concrete mix as the APC walks the fluidity up to a specific target workability. The curve represents the mixer power as a function of time, providing the primary empirical proof for the system's ability to execute a series of intentional, small-volume chemical doses delivered by the admixture delivery system (34). In this application, the APC autonomously controls the optimization loop by forecasting the workability decay and determining the exact quantity and timing of the incremental doses needed to reach the target workability plateau. This ensures that the concrete production remains efficient and consistent without the lag times or overshooting typical of human-driven or reactive control loops.

This optimization protocol initiates when the APC detects that the internal mechanical resistance, manifested as high mixer power, indicates a workability state or additional fresh concrete properties, such as air percentage, specific weight, segregation, and water discharge, that are below the desired target, for example, triggering at a total dose threshold of 0.35% or 0.40%. In response to this detection, the APC commands the introduction of seven distinct increments of chemical admixtures. As evidenced by the steps in the curve, these increments are precisely calibrated to decrease in volume as the target is approached, typically ranging from initial doses of 0.1% down to fine-tuning doses of 0.05% of the total cement weight. This granular control is a critical technical requirement for the stable application of sensitive carboxylate-based admixtures, which are susceptible to over-fluidization if added in large, uncontrolled volumes.

Each discrete dose within the loop results in a purposeful and controlled drop in the mixer power. Following each addition, the APC enforces a homogenization window to allow the chemical molecules to distribute and adsorb onto the cement grains. This results in the characteristic visual profile of a series of intentional steps, where the power decreases and subsequently stabilizes into a mini-plateau before the next dose is evaluated.

The homogenization is verified by monitoring a coefficient of variation (CoV) of the sensory array feedback until the feedback returns to the steady-state baseline. These stability plateaus provide empirical evidence that the mix remains cohesive and integrated throughout the transition, effectively avoiding the risks of segregation or bleeding.

In some embodiments, the APC embedded in the processing unit (24) is configured as a proactive AI-based control system. As described in the earlier disclosures of the inventor, specifically U.S. Patent Publication No. 2025/0059101 A1, the entire disclosure of which is incorporated herein by reference, a proactive architecture is defined by its capacity to anticipate and fulfill system needs without external prompting. While the foundational proactive AI, which is disclosed in US 2025/0059101 A1, focused on the predictive monitoring of bulk macroworld workability properties, such as slump, the APC of the present invention represents an evolution into a kinetic management architecture.

Unlike the foundational proactive AI, which operated primarily on a reactive feedback loop for slump correction, the present APC manages the microworld kinetics of the concrete mix by identifying the specific chemical receptivity state of the cement particles. The APC of the present invention achieves this by executing the multi-modal normalization of both visual kinetic markers and mechanical signals, a technical feature not present in the earlier AI disclosures. By normalizing visual flow characteristics, such as vortex depth H and flow angle α, against the real-time rotational speed and concrete volume, the present APC isolates the material state from mechanical variables with a degree of precision that allows for the management of molecular lubrication and the prevention of competitive adsorption.

Furthermore, while earlier systems identified workability shifts, the present APC is specifically configured to identify the triple-event plateau. This advanced logical layer allows the APC to calculate the dynamic saturation index (DSI) as a function of specific material variables. Consequently, the APC utilizes historical data and real-time information to initiate actions before a detrimental event, such as the formation of localized chemical hot spots or the onset of segregation, can occur, ensuring the production remains efficient and consistent without the lag times typical of earlier proactive systems.

The optimization loop shown in FIG. 19A serves as the foundational enabling evidence for the method claims involving iterative feedback control. By executing this staircase protocol, the APC (24) can precisely hit a target workability without overshooting, a feat that is often impossible with traditional manual or single-dose systems or earlier-generation AI controllers that lacked the multi-modal normalization and kinetic stabilization checkpoints of the present invention. This data confirms the role of the APC as a high-precision rheological gatekeeper, ensuring that the minimum required chemical volume is utilized to achieve the maximum technical effect while maintaining the structural health and uniformity of the cohesive mix.

Reference is now made to FIG. 19B, which illustrates the identification of a mixture breaking point and provides the technical foundation for the safety and quality control interlocks of the present invention. The graph depicts the power consumption signature associated with concrete segregation and bleeding, which occurs when a non-optimal chemical addition protocol, such as the sudden introduction of a full dose without incremental moderation, causes a catastrophic failure in the rheological stability of the mix. This breaking point represents a state where the internal cohesion of the concrete is lost, leading to the physical separation of the cement paste from the aggregate matrix.

As illustrated by the experimental curve in FIG. 19B, the failure is characterized by a sudden and unstable drop in mixer power, from approximately 62 W down to 56 W, that occurs independently of any deliberate dosing action at around the 22-minute mark. This phenomenon is a direct result of the loss of internal friction within the drum (12). When a mixture undergoes segregation or water discharge, the lubricating layer becomes excessive and non-integrated, causing the aggregates to settle while the fluid phase accumulates at the surface. The APC (24) is programmed to identify this specific signature as a broken mixture event. In response to such detection, the processing unit executes a safety interlock to prevent the discharge of the concrete mix.

The mechanical signature of this failure is visually confirmed by the embedded image in FIG. 19B obtained with the camera (38) that captures the concrete mix at the precise moment of the breaking point. This image depicts a mix that has lost all structural cohesion, showing a chaotic separation where the coarse aggregates have settled and an excessive, fluid cementitious paste layer has accumulated on the surface. By detecting the precise mathematical derivative of this unstable power drop and validating it against this visual evidence of segregation, the APC acts as a safety interlock, preventing the delivery of a ruined batch and triggering an immediate alert to the operator to halt production before the material is discharged into the delivery vehicle.

The ability of the APC to distinguish between a healthy workability plateau and a segregated failure state is fundamental to the industrial reliability of the invention. While traditional systems may misinterpret a drop in resistance as a successful fluidization, the multi-modal sensors of the present invention cross-reference the power drop with acoustic data from the sensor (20) and visual flow profiles.

A healthy mix being a stable mix possessing the required properties, maintains a stable hydraulic pressure and acoustic dampening alongside a consistent flow angle, whereas a segregated mix exhibits erratic hydraulic and acoustic sloshing and a collapse in the vortex depth. Identifying the stabilization event involves detecting a steady-state plateau in the rate of change where a mechanical resistance variance, such as hydraulic pressure variance, falls below a predetermined threshold. This real-time diagnostic capability ensures that the kinetic management system not only optimizes for performance but also maintains a rigorous boundary for structural integrity.

In other embodiments, the system achieves a significant reduction in raw material consumption, including water and cement, by waiting for the stabilised equilibrium state. This identification of the aforementioned stabilization event signifies that the mix is physically and chemically ready for dosing.

Reference is now made to FIG. 20, which illustrates the unexpected results regarding water and cement reduction that define the sustainability and non-obviousness of the present invention. The bar chart compares a traditional mix prepared with standard batching methods against a kinetic optimized mix processed according to the late-addition protocol described herein. The experiment proves that by utilizing the precise kinetic window of 5 to 15 minutes for the introduction of carboxylate-based admixtures, the chemical efficiency of the admixtures is maximized to a degree that allows for a significant reduction in primary raw materials.

The experimental data for the traditional mix shows that a water content required for the concrete batch preparation is 210 kg/m³ and a cement content is 280 kg/m³ to achieve a slump of 210 mm. In stark contrast, the kinetic optimized mix utilizes the system's ability to identify the stabilization event to reduce the water consumption to 150 kg/m³ and the cement content to 200 kg/m³. Despite this massive reduction of 60 kg/m³ of water and 80 kg/m³ of cement compared to the traditional mix, the final workability of the mix actually increases to a superior slump level of 260 mm. This simultaneous improvement in fluidization alongside a drastic reduction in material inputs is a technical outcome that contradicts conventional expectations in concrete production, where workability is typically sacrificed when cementitious content is lowered.

As explained above, the physical mechanism behind this efficiency gain is rooted in the essential prevention of competitive adsorption and the avoidance of premature chemical sequestration within the aggregate pores and the effect of the initial chemical reactions. By waiting for the moisture stabilization plateau and the first step of the chemical reactions, the APC ensures that every molecule of the admixture is available to coat the cement grains and facilitate dispersal, thereby reducing the adsorption of the admixture in the aggregates and its loss of activity from the initial reaction of the cement.

The processing unit identifies a reduction in total content of cement and, optionally, mineral additives, and commands a corresponding reduction in water content to maintain a target water-to-binder ratio. This allows for the production of green concrete with a significantly lower carbon footprint and higher compressive strengths, as the lower water-to-cement ratio inherently improves the density of the final hardened matrix.

In addition, producing concrete with stable properties through the APC allows for the successful use of simpler admixtures in significantly lower quantities and the ability to use low-quality aggregates. FIG. 20 thus provides the empirical proof for the green concrete aspect of the invention, demonstrating that high-performance concrete can be achieved with a total admixture volume and raw material cost significantly lower than that of traditional mixing protocols.

In further embodiments, the APC identifies a thermal inversion signature characteristic of high-absorption raw materials and automatically adjusts the duration of the delay interval or the sequence of the staged dosing protocol to counteract premature chemical sequestration and moisture loss.

Reference is now made to FIG. 21A, which shows the results of a technical evaluation conducted to verify efficacy and performance of the kinetic management system when processing concrete mixes containing high-absorption raw materials. For the purpose of this particular evaluation, the concrete batches were prepared using sands and fine aggregates characterized by high porosity and the presence of clay contaminants. These particular material variables, which define the aggregate quality and the presence of contaminants, are identified by the APC as factors for calculating the dynamic saturation index (DSI).

Such thirsty materials are known to create a significant challenge for traditional concrete production by neutralizing the activity of chemical admixtures, particularly carboxylate-based polymers. They also sequester both the mixing water and the active chemical molecules into their internal pores rapidly, before the chemicals can successfully interact with the cement grains. This physical sequestration prevents the admixtures from successfully adsorbing onto the external surfaces of the cement grains, thereby necessitating a more sophisticated kinetic management approach than that offered by traditional production methods specifically by identifying the aforementioned triple-event plateau.

FIG. 21A provides the mechanical proof that the staged addition protocol successfully overcomes this sequestration effect. In a traditional initial loading scenario, the aggregates immediately absorb the liquid phases, leading to a rapid and steady increase in mixer power as the internal mechanical resistance rises and workability fails. Conversely, the multi-stage protocol managed by the APC introduces very small increments of the chemical admixtures, such as 0.35% and 0.40% doses, at precise temporal points where the system detects the onset of slump loss.

The APC facilitates this protocol by normalizing the primary electronic signal comprising visual data and the auxiliary electronic signals against the rotational speed and concrete volume of the drum. This normalization allows the system to establish a steady-state baseline and quantify the total required volume of chemical admixture for each dose in the staged dosing protocol. By compensating for the continuous moisture and admixture absorption occurring throughout the production cycle, the system ensures that the chemical energy remains active on the surface of the cement particles. This strategic timing maintains a consistent fluidity and facilitates a substantial reduction in total water and cement content without sacrificing the final workability of the batch.

In some additional embodiments, the APC maintains chemical efficacy throughout the production cycle when processing porous or contaminated aggregates. This result is achieved by identifying the aforementioned triple-event plateau.

FIG. 22 shows the high-absorption performance comparison, providing quantitative evidence of the technical effect achieved through the present invention. This comparison demonstrates that the late and gradual addition of admixtures allows for the achievement of a target workability while simultaneously reducing the volume of water and cement compared to traditional production. Traditional methods, which fail to account for the continuous moisture sequestration of thirsty contaminated aggregates, typically result in an unnecessarily high water-to-cement ratio and substandard workability. The APC calculates a delay interval as a dynamic saturation index (DSI) based on the multi-modal data and identified material variables to ensure the mix reaches its target material property throughout a projected operational window until a final placement or discharge event.

The kinetic management system, by identifying the specific moisture state and applying the staged addition, maintains the chemical efficacy throughout the production cycle. Consequently, as shown in the data, the mixture requires significantly less water to reach a superior slump and achieves a higher 28-day compressive strength. This improvement is a direct result of the improved densification of the concrete matrix, as the lower water-to-cement ratio achieved through the kinetic optimization of the APC leads to a more robust and less porous hardened structure. The APC verifies that the mixture has reached a chemical receptivity state before initiating the staged dosing protocol established in Step (V).

In a certain embodiment, the APC overcomes chemical interference by enforcing a staggered dosing protocol that separates the introduction of a water-reducing agent and a retarding agent according to a calculated chemical-receptivity window to prevent simultaneous absorption and molecular contradictions. This sequence is calculated as a function of the mix type and a projected operational window until a final placement or discharge event.

Reference is now made to FIG. 23A, which provides the empirical justification for the delay intervals utilized by the kinetic management system of the present invention to overcome chemical interference. The bar chart illustrates the resulting workability, measured as slump in mm, as a function of the addition timing for the chemical admixtures, specifically the water reducer and retarder. The experimental data clearly confirms that the late addition of chemical admixtures is essential for obtaining a higher workability level by overcoming the chemical interference that occurs when components are introduced too early in the hydration cycle.

As evidenced by the experimental data points, an immediate addition at the stationary plant at zero minutes results in a poor workability state of only 80 mm slump. However, by utilizing the kinetic management of the invention to increase the loading interval and thus delay the addition, the workability shows a significant and nearly linear improvement. A 3-minute delay yields 100 mm slump, a 6-minute delay results in 160 mm slump, and a 9-minute delay nearly doubles the initial workability to reach 190 mm slump. This significant increase confirms that the temporal separation allows the cement matrix to reach a specific receptive state before the chemical energy of the water reducer and retarder is introduced. This way, the APC enables each chemical component to interact with the cement matrix at its point of maximum receptivity, avoiding the contradictions and premature sequestration that occur in traditional production.

Reference is now made to FIG. 23B, which represents the sequence optimization chart and provides the empirical evidence for the critical order of chemical introduction required to maximize chemical efficacy. This order is defined herein as a staggered dosing protocol. While timing is a primary factor and FIG. 23A establishes its importance, FIG. 23B proves that the specific sequence of components is equally critical to prevent materials from being absorbed together and creating contradictions between disparate chemical species.

The experiment reveals a sophisticated chemical interference phenomenon, where adding the retarder before the water reducer is technically detrimental, yielding a slump of only 100 mm. Even a simultaneous addition of both agents at the 6-minute mark yields a suboptimal slump of 160 mm. However, the staggered sequence executed by the processing unit (24), where the water reducer is introduced at 6 minutes followed by the retarder at 9 minutes, allows for a staggered synergy, where each chemical interacts with the cement particles without competitive interference. This specific sequence yields a peak slump of 200 mm, identifying the primary chemical constraint that the kinetic management system of the invention overcomes to ensure non-obvious improvements in workability.

In yet another embodiment, the autonomous cyber-physical production system utilizes its APC to perform real-time air-entrainment monitoring by correlating mixer power with a non-linear exponential fit of air content and specific weight. The APC is configured to maintain the air content within a stability target zone by executing timed additions of air-entraining agents and synchronizing these releases with specific drum rotation speeds.

Reference is now made to FIG. 24A, which illustrates the power-to-air correlation used by the APC to perform real-time air-entrainment monitoring. The physical relationship between air content (φₐᵢᵣ) and mixer power P is rooted in the rheological model of fresh concrete as a Bingham plastic. In this model, the torque T, which is required to turn the mixer and consequently the power consumption P, is governed by the torque g required to initiate flow and the torque h required to maintain flow at a certain speed N, according to the relationship: P∝T=g+hN. In this equation, the torque g relates to the yield stress τ₀ and the torque h relates to the plastic viscosity u. When air is entrained into the mix, millions of microscopic bubbles are introduced that act as ball bearings within the matrix, reducing the internal friction between the solid aggregates and the cement paste, thereby lowering both the yield stress and the effective volume fraction of solids (φ), which in turn reduces viscosity.

According to the Krieger-Dougherty equation, the viscosity of the suspension n is highly sensitive to this volume fraction of solids φ. As the air content φₐᵢᵣ increases, the volume fraction of solids φ decreases, resulting in a monotonically decreasing curve for power consumption as illustrated in FIG. 24A. The processing unit (24) utilizes this non-linear exponential fit to correlate the mixer power P with the air percentage. This allows the APC to identify the exact real-time air content based on the mechanical sensor feedback, ensuring high precision in detecting the structural state of the concrete mix. The APC is therefore capable of acting as a real-time monitor, ensuring that the air-entrainment remains within the target range for freeze-thaw durability without the need for manual testing.

Reference is now made to FIG. 24B, which depicts the air content stability profile, illustrating the system's ability to maintain a stable and unchanging air percentage. Traditional production methods often suffer from an unstable entrained air percentage, which can collapse from an initial 10% to 4% or lower by the time the delivery vehicle reaches the site. The APC identifies the signature of this air loss by detecting a corresponding increase in mixer power as the lubricating ball-bearing effect of the air bubbles diminishes. By executing a timed, late addition of air-entraining agents, the APC maintains a stable plateau of the air content within a stability target zone of about 5% to about 7%, or any other target material property as specified in the operator-defined configuration.

Reference is now made to FIG. 24C, which illustrates the critical impact of mixing energy, measured as drum rotation speed in RPM, on the stability of entrained air. The experimental results show that adding an air-entraining agent at a low rotational speed, represented by the solid curve, results in a significantly higher and more stable air content of approximately 10.5%. In contrast, addition at high rotational speeds, represented by the dashed curve, yields only 6%, while traditional loading decays toward 4%. This proves that the APC must not only trigger the admixture release but also synchronize said release with an adjustment of the drum speed to a specific entrainment window to achieve the target air percentage with the lowest possible chemical dosage.

In a specific embodiment, the APC executes a density-air cross-validation protocol, wherein mechanical resistance data is cross-referenced with material specific weight to distinguish between workability changes caused by chemical liquefaction and those caused by air-void systems. It is important to note that beyond monitoring air entrainment via mixer power, it is technically advantageous to correlate these mechanical signatures with the specific weight (density) of the mix. This is a critical issue because while air entrainment reduces mixer power, a change in raw material density or batch volume can produce similar signatures.

Reference is made to FIG. 24D further supporting the multi-modal validation of these air-entrainment states. This figure provides a graphical representation of the direct correlation between mixer power (W) and the specific weight of the fresh concrete mix (kg/m³). As illustrated by the upward-sloping curve, the APC identifies that as the specific weight of the mixture increases (indicating a denser mix with less air), the mixer power required to rotate the drum (12) also increases. This correlation to specific weight provides a powerful diagnostic tool, as it allows the APC to verify that a drop in mixer power is the result of air entrainment (which reduces specific weight) rather than a change in batch volume. In other words, the APC can cross-validate that a drop in power is indeed caused by the lubricating effect of air bubbles rather than a change in the material matrix or batch size, thereby increasing the system's diagnostic precision. Thus, by cross-referencing mechanical resistance with material density, the APC ensures the structural durability of the final concrete product.

In a particular embodiment, the APC is configured to identify a mixture breaking point by detecting a simultaneous erratic spike in the acoustic noise signature and a rapid collapse in mixer power. The step of detecting a mixture breaking point comprises identifying a rapid downward spike or a drop in hydraulic pressure in the auxiliary electronic signal occurring simultaneously with a threshold increase in an acoustic signal and a visual detection of aggregate segregation via the primary electronic signal. The APC is programmed to execute a safety interlock to inhibit discharge upon the detection of these mechanical and visual markers of segregation.

Reference is now made to FIG. 25A and FIG. 25B, which illustrate the identification of a concrete mix breaking point and the activation of the safety interlock by the APC. As illustrated in FIG. 25A, the safety interlock protocol is triggered by the detection of a sudden mechanical collapse of the mixture, which occurs when the aggregates separate from the cement paste due to over-dosing or excessive water. Because the liquid phase bleeds out of the matrix, it acts as an unplanned lubricant, leading to a sharp decrease in the mixer power as the blades no longer encounter a cohesive solid.

This failure is uniquely identified by the APC through a specific erratic spike in the power curve, which is accompanied by a simultaneous spike in the acoustic noise signature. The APC identifies this signature as the onset of water bleeding and segregation. To complement the mechanical data, the APC also identifies specific breaking point visual markers via the camera (38), such as the downward flow of cementitious paste from the upper vanes and the formation of a static water layer. Upon the simultaneous detection of these erratic signatures, the system activates the safety interlock to prevent the discharge of the ruined batch.

FIG. 25B further provides the empirical evidence for this diagnostic claim, showing that after a cumulative addition of 1.35% admixture in a cement reduction protocol, the power consumption drops sharply from 62 W down to 56 W, signifying the physical breaking point. In contrast, the multi-stage protocol managed by the APC remains stable at 52 W, demonstrating that the incremental dosing loop successfully avoids this threshold by maintaining mixture cohesion.

In another embodiment the APC manages a multi-stage kinetic protocol where a primary water-reducer addition is followed by a secondary corrective dose to recover workability after a slump reduction phase, as visually verified by a sequence of photographic snapshots representing the transition from a stiff, rocky state to a fluid, integrated concrete matrix.

Reference is now made to FIG. 25C, which is a composite technical illustration comprising a power consumption graph and four corresponding photographic images illustrating the mechanical and visual effects of the kinetic protocol. This figure illustrates the successful management of a complex hydration cycle where the mix undergoes a significant slump reduction phase. At time T=0, the APC initiates the protocol with an initial retarder addition and 50 percent of the required water reducer. The first photographic image corresponds to this initial state, showing a very stiff, rocky, and non-cohesive mix that results in a high initial power spike of approximately 92 W.

At the 10-minute mark, the APC identifies the need for additional fluidization and commands the addition of the remaining 50 percent of the water reducer. The second photographic image illustrates the mix at this point, showing that it has become more pasty but remains relatively stiff and heterogeneous. Following this addition, the mix enters a slump reduction phase where the power stabilizes at a lower level of approximately 75 W. The third photographic image, captured during this phase, demonstrates a visible improvement in homogeneity, though the mix has not yet reached its peak workability.

To achieve the final target workability, the APC identifies a specific rheological window at approximately the 35-minute mark and triggers a corrective addition of 0.2% water reducer. As shown in the power graph, this final dose results in a secondary drop and stabilization of the power curve. The fourth photographic image visually confirms the success of this kinetic protocol, depicting a highly workable, liquid-like, and perfectly integrated concrete mix. This sequence provides conclusive proof that the autonomous cyber-physical production system can proactively navigate through periods of slump loss to deliver a batch in its optimal state.

In another embodiment, the APC neutralizes natural slump loss over extended durations by executing a staged dosing protocol based on real-time sensor feedback. The APC is configured to maintain a constant rheological state, as evidenced by a stable power profile, ensuring that the concrete arrives at the site in the exact condition required for the structural application regardless of the temporal lag between the plant and the site.

Reference is now made to FIG. 26, which provides a technical comparison between traditional production and the kinetic production methodology of the invention regarding the maintenance of workability over an extended 40-minute window. In traditional production, where the chemical interaction initiates immediately and subsequently decays, the concrete suffers from a steady increase in mechanical resistance as it stiffens. As illustrated by the dashed curve, this results in a power climb from 54 W to 59 W, representing a continuous decrease in flow and workability over time.

Conversely, the advanced kinetic production methodology utilized by the APC (24) introduces admixtures precisely to maintain a constant and high flow over the same duration. The experimental results show that the advanced production curve remains perfectly stable between 48 W and 50 W throughout the 40-minute window. By using real-time sensor data to trigger the staged dosing protocol, the APC ensures that the workability plateau is maintained regardless of environmental exposure or transit time. This constant rheological state ensures that the final concrete product delivered to the site is in the exact condition required for high-performance structural applications.

In one embodiment, the autonomous cyber-physical production system comprises a fleet-level integration where the APC of each delivery unit is networked to a stationary batching plant to perform real-time recipe corrections based on predictive kinetic feedback. In another embodiment, the system enters a correction state during the transit phase, where the APC identifies deviations in material performance and communicates next-batch optimization parameters to the stationary plant to prevent the propagation of errors across a fleet.

Reference is made to FIG. 27, which illustrates the system-level architecture and fleet-level feedback logic, which is the network brain of the industrial implementation. Unlike previous figures that focus on the internal physics of a single mix, FIG. 27 defines how individual kinetic signatures, including power, temperature, noise, and image processing data, are transmitted across a network to optimize the entire production chain. The system enables a real-time communication network where each mobile delivery unit reports the properties of its fresh concrete to a central hub or the stationary plant.

As illustrated in the figure, the stationary plant can adjust the chemical composition for subsequent trucks based on properties received from the current batch mixer. For instance, if the APC on the current mixer identifies that the raw materials are absorbing more water than predicted via the thermal inversion signature described in FIG. 21B, this information is instantly transmitted back to the plant. The central AI automatically calculates a recipe correction for the subsequent batch mixer. If the APC on the current mixer identifies a deviation in the rate-of-change curve indicating, for example, that the raw materials are absorbing more water than predicted or that the cement composition is accelerating hydration, this information is instantly transmitted back to the plant. This allows the system to function as a continuous manufacturing line that extends from the batching bay to the discharge site, ensuring fleet-wide uniformity

The system enters a correction state where the processing unit (24) receives real-time data from a mixer during its transit phase. While the mixer is rotating, the system analyzes its overall performance to identify deviations reflected in the rate-of-change curve, such as hydration rate shifts, contaminant influence, or aggregate moisture variances. These recipe corrections are communicated to the stationary batching plant, ensuring that every stationary mixer and every truck in the fleet delivers identical concrete quality regardless of environmental shifts or raw material variability. The system optimizes the subsequent batch by adjusting the water-to-binder ratio or admixture dosage based on the multi-modal analysis of the current batch.

In a particular embodiment, the APC is configured to perform microworld monitoring of the concrete matrix by utilizing high-frequency sensor data to predict microscopic processes at the cement particle surface, such as hydration layer formation and admixture adsorption, to determine the chemical state of the mix independently of raw physical parameters.

Reference is now made to FIG. 28, which provides a comparative illustration between macroworld monitoring and the microworld monitoring executed by the APC to understand the true chemical state of concrete mix and define the proactive nature of the Sensolyzer™ system. As shown in the upper portion of the figure, macroworld monitoring involves the observation of bulk physical parameters such as mix temperature and drum speed. While these parameters provide a high-level overview of the production cycle, they do not reveal the underlying kinetic processes that govern workability and structural integrity.

In contrast, the APC performs a dramatic zoom into the cement matrix, as indicated by the downward arrow, to show microworld monitoring of the microscopic environment. In this microworld, the APC identifies individual cement particles (290), such as tricalcium silicate or dicalcium silicate, and monitors the cement particle surface (280) by utilizing molecular level data to predict the chemical state of the mix. This involves the real-time observation of microscopic processes at the cement particle surface (280), including the formation of the hydration layer (281) on the particle surface (280) with the water phase.

By monitoring molecular processes in real time, the APC also tracks the movement and interaction of chemical admixture molecules (282) in the interstitial fluid and their adsorption to the particle surface (280). The APC identifies the specific moment of adsorption where the admixture molecules (282) anchor to the cement particle surface (280) to form an adsorbed admixture layer (283). The APC further monitors the surface charge interactions (284) occurring at the interface between the particles and the water phase. By focusing on this microworld, the autonomous cyber-physical production system can act on the underlying chemical causes of workability loss and predict the course of actions based on the actual chemical receptivity of the matrix rather than merely reacting to mechanical symptoms.

In a certain embodiment, the APC manages the introduction of chemical admixtures to form a molecular lubrication layer around individual cement particles, thereby minimizing inter-particle friction and preventing material clumping associated with a standard mix. The physical mechanism of this microworld monitoring is further detailed in FIG. 29, which illustrates the principles of molecular lubrication managed by the APC to achieve sustainable energy gains. In a standard concrete mix, as shown in the upper panel, the cement particles (290) are prone to flocculation or clumping, which creates significant internal friction (291). These particles stick together and collide during mixing, generating high mechanical resistance that requires a high torque from the mixer motor to maintain rotation.

In contrast, the APC manages the introduction of chemical admixtures to execute the molecular lubrication protocol, as shown in the lower panel. The APC ensures that each individual cement particle (290) is properly coated at a molecular level. This precise management results in the formation of a molecular lubrication layer (292) around each particle, which serves to neutralize surface charges and minimize inter-particle friction. This molecular lubrication layer (292) corresponds to the adsorbed admixture layer (283) described in FIG. 28, representing the same physical coating of chemical molecules but serving the functional purpose of friction reduction rather than chemical state verification.

Because the internal friction is minimized, the properly lubricated particles can move along managed flow paths (293) within the matrix. This managed rheological state achieves a significant reduction in the total mechanical resistance of the concrete, which directly translates to a lower torque requirement for the mixer drum. Thus, by precisely coating each particle, the kinetic management protocol achieves a significant reduction in the internal molecular friction of the concrete mix, which directly translates to a lower torque requirement for the mixer drum. Consequently, the APC achieves a high-performance concrete mix with lower fuel or electricity consumption, making the production process an eco-friendly and highly sustainable industrial solution.

In a major embodiment, the autonomous cyber-physical production system of the invention achieves a sustainable energy gain by reducing the mechanical torque requirements of the mixer drum through advanced chemical-kinetic management of the cement matrix, as evidenced by a stabilized and lower torque profile over time compared to a standard mix. The empirical results of this molecular lubrication are shown in FIG. 30, which provides a torque requirement comparison. A first data curve illustrates the high and erratic torque levels of a standard mix. A second data curve illustrates the stabilized and lower torque profile achieved by the autonomous cyber-physical production system. The vertical displacement between these curves represents a sustainable energy gain. By reducing the mechanical resistance of the mix through advanced chemical physics, the system achieves lower fuel or electricity consumption, making the Sensolyzer™ process a highly sustainable solution for concrete manufacturing.

Throughout the dosing and stabilization phases, the magnitude of each incremental dose is dynamically adjusted as a function of the deviation between the steady-state baseline and the target material property. The target material property serves as a numerical set-point for parameters such as slump, air content, or specific weight. The APC (24) executes a proportional adjustment logic where the volume of each dose is modulated based on the size of the detected deviation. This ensures that the APC precisely navigates the mix toward the desired state without overshooting the target or causing mixture instability.

### CONCLUSION

The present invention represents a fundamental shift in concrete production technology by transitioning from static, recipe-based batching to a dynamic, multi-modal kinetic management paradigm. As demonstrated through the extensive experimental data provided in the present invention, the system successfully navigates the complex rheological and chemical transitions that occur during the initial hydration phase. By utilizing an APC (24) to monitor the internal state of the mix through the fusion of mechanical, thermal, visual, and acoustic signatures, the invention overcomes the primary technical barriers of competitive adsorption and premature chemical sequestration. The identification of the moisture stabilization plateau and the subsequent implementation of a staggered dosing protocol ensure that chemical energy is applied only when the cementitious matrix is most receptive, thereby maximizing the efficiency of modern admixtures.

A critical technical outcome of this methodology is the achievement of unexpected and surprising results regarding raw material optimization. The ability to reduce the required dosage of chemical admixtures, as well as water consumption by up to 60 kg/m³ and cement content by 80 kg/m³ while simultaneously increasing workability from 210 mm to 260 mm slump represents a significant departure from conventional concrete science. This breakthrough is facilitated by the capacity of the APC to maintain a precise thermal delta of 0.3° C. during the critical addition window, preventing the hydration heat from accelerating prematurely and allowing for a controlled, stable workability plateau over extended transport durations of up to 40 minutes.

Furthermore, the handling of high-absorption and contaminated aggregates through the thermal inversion signature ensures that the system remains robust across a diverse range of raw material qualities, providing a consistent product regardless of environmental or constituent variability.

Beyond performance optimization, the invention provides a comprehensive safety and quality control framework through its automated diagnostic capabilities. The identification of the breaking point and the subsequent activation of safety interlocks prevent the delivery of non-conforming, segregated batches, thereby protecting the structural integrity of the final construction project.

The versatility of the autonomous cyber-physical production system allows for its application in advanced manufacturing environments, including 3D printing and the production of specialized formulations such as geopolymer concrete, or mixtures requiring specific catalysts, or admixtures for extended workability retention. The architecture supports both fully autonomous operation and manual intervention, enabling remote operators or vehicle drivers to trigger or override dosing protocols as required.

The reliability of the system is further enhanced by a sensor-redundancy protocol, ensuring that the APC can maintain stable production and safety monitoring even if a subset of the multi-modal sensory array is unavailable. When scaled to a fleet-level architecture, the system enables a network brain where real-time feedback from mobile units informs the central batching plant, creating a closed-loop production chain that minimises cumulative errors and enhances industrial sustainability.

In summary, the kinetic management system provides a technically superior, environmentally responsible, and commercially viable solution for the precision manufacture of high-performance concrete in modern construction environments by establishing a continuous manufacturing bridge between the stationary batching plant and the final placement site.

1. A method for precision dosing of chemical admixtures into a fresh concrete mix within a rotating mixing drum via an autonomous processing core (APC) implemented by a processing unit, the method comprising:
(I) sampling, via the processing unit, multi-modal data comprising a primary electronic signal including visual data from a camera and one or more auxiliary electronic signals selected from a group consisting of a hydraulic pressure signal, an acoustic signal, a temperature signal, and a rotational speed signal;
(II) normalizing, via the processing unit, the primary electronic signal and the one or more auxiliary electronic signals against a rotational speed and a concrete volume of the rotating mixing drum and calculating a rate of change for the normalized signals;
(III) identifying, via the processing unit, a stabilization event representing conclusion of at least one of an initial aggregate absorption phase, contaminant saturation, and initial hydration reactions by:
(a) correlating the calculated rate of change calculated in Step (II) with normalized visual flow or slump characteristics from the primary electronic signal;
(b) detecting a steady-state plateau in the rate of change where a mechanical resistance variance falls below a predetermined threshold; and
(c) cross-validating the plateau through real-time image processing of normalized visual kinetic markers and flow patterns from the primary electronic signal;
(IV) executing a control interlock, via the processing unit, in response to the stabilization event identified in Step (III) to inhibit an admixtures delivery system for a delay interval, wherein the delay interval is calculated by the processing unit as a dynamic saturation index (DSI) based on the multi-modal data sampled in Step (I) and at least one material variable selected from a group consisting of an aggregate quality, a mix type, and a presence of contaminants;
(V) upon expiry of the delay interval of Step (IV), determining a staged dosing protocol via the processing unit, by:
(i) establishing a steady-state baseline for the auxiliary electronic signals normalized in Step (II);
(ii) quantifying a total required volume of at least one chemical admixture by correlating said steady-state baseline with the visual flow or slump characteristics from the primary electronic signal; and
(iii) generating a sequence of a plurality of incremental doses and corresponding homogenization windows, wherein the magnitude of each dose is dynamically adjusted as a function of deviation between the steady-state baseline and a target material property; and wherein the sequence is calculated as a function of the mix type and a projected operational window until a final placement or discharge event; and
(VI) directing the admixtures delivery system to execute the staged dosing protocol established in Step (V) by introducing the plurality of incremental doses of at least one chemical admixture, wherein each subsequent dose is inhibited until the processing unit identifies a return to the steady-state baseline in at least one of the primary or auxiliary electronic signals, indicating completion of a chemical dispersion over a homogenization window.

2. The method of claim 1, wherein the stabilization event is a triple-event plateau signifying the simultaneous conclusion of the initial aggregate absorption phase, the contaminant saturation, and the initial hydration reactions.

3. The method of claim 1, wherein identifying the stabilization event in Step (III) comprises identifying a kinetic stabilization of initial hydration reactions involving the aluminate components, specifically tricalcium aluminate (C₃A) and tetracalcium aluminoferrite (C₄AF), and the silicate components of the cement within the fresh concrete mix by detecting at least one of a thermal equilibrium, a rheological equilibrium, or a mechanical equilibrium, or a combination thereof, wherein:
the thermal equilibrium is identified by a thermal plateau in a temperature signal following an initial exothermic hydration peak;
the rheological equilibrium is identified by a predetermined frequency shift in an acoustic signal sampled as part of the auxiliary electronic signal, representing a transition in interstitial fluid viscosity; and
the mechanical equilibrium is identified by the steady-state plateau in the auxiliary electronic signal established in Step (II) representing a reduction in inter-particle friction, wherein said auxiliary electronic signal comprises a motor hydraulic pressure signal or an internal pressure signal sampled from a sensor submerged in the fresh concrete mix.

4. The method of claim 1, wherein the staged dosing protocol comprises delivering at least a first chemical admixture from a first reservoir, or sequentially delivering a first chemical admixture from a first reservoir and a second chemical admixture from a second reservoir separated by a chemical-separation interval to prevent competitive adsorption on cement grains.

5. The method of claim 4, wherein the first chemical admixture is a water-reducing agent provided with a solids content of 40% or less suitable for increasing the dispersal rate and technical efficacy during the homogenization window.

6. The method of claim 1, further comprising identifying a correlation between a decrease in the auxiliary electronic signal and an increase in an air content percentage or a deviation in a rheological stability range of the concrete mix, and adjusting a magnitude of the incremental doses in Step (VI) and/or adjusting the rotational speed of the rotating mixing drum to maintain the concrete mix within a target material property corresponding to a desired air content percentage.

7. The method of claim 1, further comprising a cement-reduction protocol wherein the processing unit identifies a reduction in total content of cement and, optionally, mineral additives, and commands a corresponding reduction in water content to maintain a target water-to-binder ratio, wherein the incremental doses of chemical admixtures are increased in staircase steps until the processing unit identifies a state approaching segregation or bleeding, at which point the processing unit executes a safety interlock to terminate the staged dosing protocol.

8. The method of claim 1, further comprising executing a sensor-fusion confidence protocol, performed during an initial loading and wetting of raw materials, wherein the processing unit assigns a higher reliability weight to the auxiliary electronic signal and a lower reliability weight to the primary electronic signal to mitigate environmental noise, and wherein the processing unit dynamically increases the reliability weight of the primary electronic signal following identification of the stabilization event in Step (III).

9. The method of claim 1, further comprising:
sampling ambient temperature and humidity;
identifying a hydration state of the fresh concrete mix, a workability deviation, or a presence of clay contaminants, dust, low quality of aggregates, or organic matter by indexing a deviation in the temperature signal combined with a threshold change in the acoustic signal, the hydraulic pressure signal, or the primary electronic signal, against the sampled ambient temperature and humidity to isolate material kinetics from environmental variables; and
automatically adjusting the duration of the delay interval in Step (IV) in response to said identification.

10. The method of claim 1, further comprising the step of detecting a mixture breaking point by identifying a rapid downward spike or a drop in hydraulic pressure in the auxiliary electronic signal occurring simultaneously with a threshold increase in an acoustic signal and a visual detection of aggregate segregation via the primary electronic signal, wherein, in response to said detection, the processing unit executes a safety interlock to prevent the discharge of the concrete mix.

11. The method of claim 1, further comprising an optional manual processing mode wherein the processing unit is configured to receive remote decision commands from an external supervisor or local decision commands from a vehicle driver to manage the staged dosing protocol.

12. An autonomous cyber-physical production system for proactive management of concrete production, comprising:
(a) an active hardware matrix comprising:
(1) a rotating mixing drum,
(2) a sensor assembly mounted on a support frame adjacent to the rotating mixing drum, the sensor assembly housing a camera for visual feedback as a primary electronic signal,
(3) at least one auxiliary sensor selected from a group consisting of:
an acoustic sensor (20) housed within the sensor assembly (40);
a hydraulic pressure transducer (26) fluidly coupled to a hydraulic motor of the rotating mixing drum (12), and/or an internal drum pressure sensor submerged inside a concrete matrix within the rotating mixing drum (12);
an environmental temperature and humidity sensor; and
a temperature sensor mounted at a rear access point (36) of the rotating mixing drum (12) for monitoring a thermal profile of the fresh concrete mix; and
(4) an admixtures delivery system comprising one or more independent reservoirs for chemical admixtures; and
(b) an autonomous processing core (APC) implemented by a processing unit in communication with the active hardware matrix, the processing unit configured to:
(i) normalize an auxiliary electronic signal from the at least one auxiliary sensor against drum rotational speed and concrete volume;
(ii) identify a stabilization event representing a conclusion of at least one of an initial aggregate absorption phase, contaminant saturation, and initial hydration reactions;
(iii) calculate a dynamic saturation index (DSI) based on hydraulic, thermal and acoustic signatures to determine a chemical receptivity state of the concrete mix; and
(iv) execute a staged dosing protocol on the admixtures delivery system to dispense incremental doses as a function of deviation between a steady-state baseline and a target material property.

13. The system of claim 12, wherein the processing unit is further configured to monitor signal noise including mechanical resistance and hydraulic pressure variance to execute a coefficient of variation (CoV) protocol for homogenization verification.

14. The system of claim 12, wherein the processing unit is configured to extract a flow angle, a vortex depth, a material cohesiveness, a presence of clumps, and a bleeding state from visual data provided by the camera as a visual proxy for viscosity, yield stress, and homogenization.

15. The system of claim 12, wherein the APC is configured to generate a predictive model of a hydration curve and an absorption curve based on the multi-modal data and at least one external logistical variable selected from a group consisting of transit time, ambient temperature at the discharge site, and structural requirements, to calculate a projected slump-life window and pre-emptively adjust the target material property and/or the staged dosing protocol as a function of predicted workability loss.

16. The system of claim 12, wherein the fresh concrete mix is a geopolymer mixture, a high-strength concrete mixture, concrete mixes requiring different initial and final setting times, concrete formulations with distinct slump or flow levels, or a mixture for 3D-printing, and the processing unit is configured to perform real-time monitoring of setting times and adjust for non-standard technological requirements including extreme retardation or acceleration.

17. The system of claim 12, wherein the APC is configured to perform microworld monitoring of a cement matrix (binder) by utilizing high-frequency sensor data to predict microscopic processes at a cement particle surface, including hydration layer formation and admixture adsorption.

18. A method for networked management of a concrete production sequence, the method comprising:
(I) sampling multi-modal data from a first fresh concrete mix within a first rotating mixing drum via an autonomous processing core (APC);
(II) identifying a kinetic signature of the first fresh concrete mix, the kinetic signature comprising a rate-of-change curve representing stability and performance transitions, by normalizing an auxiliary signal against drum speed and concrete volume;
(III) transmitting the kinetic signature from the first rotating mixing drum to a stationary batching plant; and
(IV) facilitating a predictive recipe correction (redesigning concrete mix components) for a second concrete mix in a delivery sequence at the stationary batching plant based on the kinetic signature sampled from the first fresh concrete mix.

19. The method of claim 18, wherein the kinetic signature identifies a presence of clay contaminants, high dust content, or an uncharacteristic hydration state to trigger the predictive recipe correction.

20. The method of claim 18, wherein the predictive recipe correction comprises adjusting a water-to-binder ratio or an admixture dosage for the second concrete mix before it is loaded into a second rotating mixing drum.
